(19) United States
(12) Patent Application Publication
(10) Pub. No.: US 2009/0284515 A1
(43) Pub. Date: Nov. 19, 2009

(54) EL DISPLAY DEVICE

(75) Inventor: Hitoshi TSUGE, Osaka (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toshiba Matsushita Display Technology Co., Ltd., Tokyo (JP)

(21) Appl. No.: 12/466,851

(22) Filed: May 15, 2009

(30) Foreign Application Priority Data
May 16, 2008 (JP) 2008-129549
Oct. 30, 2008 (JP) 2008-280198

(51) Int. Cl. G06F 3/038; G09G 3/30

(52) U.S. Cl. 345/211; 345/76

(57) ABSTRACT

There is provided an EL display device having a plurality of pixels arranged in a matrix pattern, wherein the pixels each include an EL element and a drive transistor configured to define a current to be supplied to the EL element, and switches configured to supply a reset power to the drive transistors of the respective pixels are provided one each for a row of the pixels arranged in the matrix pattern.

### CROSS-REFERENCE TO RELATED APPLICATIONS

This application is based upon and claims the benefit of priority from the Japanese Patent Application No. 2008-129549, filed on May 16, 2008 and the Japanese Patent Application No. 2008-280198, filed on Oct. 30, 2008, the entire contents of which are incorporated herein by reference.

### FIELD OF THE INVENTION

The present invention relates to an EL display device employing a self-emitting display panel such as an EL display panel (display device) in which an organic or inorganic electroluminescence (EL) element is used.

### DESCRIPTION OF THE BACKGROUND

An active matrix-type image display device in which an organic EL material or an inorganic EL material is used as an electro-optic converting substance varies in light-emitting luminance according to a current written in a pixel. An EL display device is of a self-emitting type having a light-emitting element in each pixel. The EL display device has advantages such that a visibility of images is high, a light-emitting efficiency is high, no backlight is necessary, and a response speed is high in comparison with a liquid crystal display panel.

In organic EL (PLED, OLED, OEL) panels, development of an active matrix system is in progress. This system is designed to control a current flowing in light-emitting elements in respective pixel circuits by positive elements (generally, thin film transistor (TFT) provided in the pixel circuits (For example, JP-A-2007-148128 (Kokai), JP-A-2003-271095 (Kokai)).

In the EL display device, display is achieved by supplying a current to EL elements and the pixel circuits have a function for converting a voltage maintained in the pixel circuit into a current, a function to maintain the voltage for one-frame period, and a function for correcting variations in current converting elements, so that the number of transistors and capacitors to be provided for one pixel circuit is large. Therefore, application of the EL display device to a display having a high definition is difficult.

Therefore, there is a method of achieving a display with a configuration of a pixel circuit 21 shown in FIG. 6 with a small number of transistors. However, a switching unit 721 is needed to realize a switching unit with a low-resistance element in order to supply a current to an EL element 15. Therefore, a circuit of the switching unit 721 is large, and there is a problem such that a frame of the display device is upsized.

In view of such problems, the invention provides an EL display device being small in frame size and having a downsized circuit in each pixel.

### SUMMARY OF THE INVENTION

According to embodiments of the invention, there is provided an EL display device having a plurality of pixels arranged in a matrix pattern, wherein the pixels each include an EL element, and a drive transistor configured to define a current to be supplied to the EL element, and switches configured to supply a reset power to the drive transistors of the respective pixels are provided one each for a row or plural rows of the pixels arranged in the matrix pattern.

In this configuration, the frame is downsized and the circuit per pixel is also downsized.

### BRIEF DESCRIPTION OF THE DRAWINGS

FIG. 1 is a drawing showing a pixel circuit of an EL display device according to a first embodiment.

FIG. 2 is a timing chart of the first embodiment.

FIG. 3 is an explanatory drawing of the EL display device according to the first embodiment.

FIG. 4 is an explanatory drawing of the EL display device according to the first embodiment.

FIG. 5 is an explanatory drawing of the EL display device according to the first embodiment.

FIG. 6 is a circuit diagram of an EL display device in the related art.

FIG. 7 is a cross-sectional view of an EL element according the first embodiment.

FIG. 8A to FIG. 8C are explanatory drawings of the EL display device according to the first embodiment.

FIG. 9 is a drawing showing a pixel circuit of an EL display device according to a second embodiment.

FIG. 10 is an explanatory drawing of the EL display device according to the second embodiment.

FIG. 11 is an explanatory drawing of the EL display device according to the second embodiment.

FIG. 12 is a drawing showing the pixel circuit of the EL display device according to the second embodiment.

FIG. 13 is a timing chart of the EL display device according to the second embodiment.

FIG. 14 is a drawing showing the pixel circuit of the EL display device according to the second embodiment.

FIG. 15 is an explanatory drawing of the EL display device according to the second embodiment.

FIG. 16 is a drawing showing the pixel circuit of the EL display device according to the second embodiment.

FIG. 17 is an explanatory drawing of the EL display device according to the second embodiment.

FIG. 18 is a drawing showing the pixel circuit of the EL display device according to the second embodiment.

FIG. 19 is a timing chart of the pixel circuit shown in FIG. 18.

FIG. 20 is an explanatory drawing of an EL display device according to a third embodiment.

FIG. 21 is an explanatory drawing of the EL display device according to the third embodiment.

FIG. 22 is an explanatory drawing of the EL display device according to the third embodiment.

FIG. 23 is an explanatory drawing of the EL display device according to the third embodiment.

FIG. 24 is an explanatory drawing of the EL display device according to the third embodiment.

FIG. 25 is an explanatory drawing of an EL display device according to a fourth embodiment.

FIG. 26 is a drawing showing a pixel circuit of the EL display device according to the fourth embodiment.

FIG. 27 is an explanatory drawing of the EL display device according to the fourth embodiment.

FIG. 28 is an explanatory drawing of the EL display device according to the fourth embodiment.

FIG. 29 is a block diagram of an EL display device according to a fifth embodiment.

FIGS. 30A and 30B are explanatory drawings showing an entire configuration of the EL display device according to the fifth embodiment.

FIG. 31 is an explanatory drawing of an EL display device according to a seventh embodiment.

FIG. 32 is an explanatory drawing of the EL display device according to the fifth embodiment.

FIG. 33 is an explanatory drawing of an EL display device according to an eighth embodiment.

FIG. 34 is an explanatory drawing of an EL display device according to a ninth embodiment.

FIG. 35 is an explanatory drawing of the EL display device according to the third embodiment.

FIG. 36 is an explanatory drawing of an EL display device according to a tenth embodiment.

FIG. 37 is an explanatory drawing of the EL display device according to the tenth embodiment.

FIG. 38 is an explanatory drawing of an EL display device according to an eleventh embodiment.

FIG. 39 is an explanatory drawing of the EL display device according to the eleventh embodiment.

FIG. 40 is an explanatory drawing of an EL display device according to a twelfth embodiment.

FIG. 41 is an explanatory drawing of the EL display device according to the twelfth embodiment.

FIG. 42 is an explanatory drawing of an EL display device according to a sixteenth embodiment.

FIG. 43 is an explanatory drawing of an EL display device according to a fourteenth embodiment.

FIG. 44 is an explanatory drawing of an EL display device according to a thirteenth embodiment.

FIG. 45 is an explanatory drawing of the EL display device according to the thirteenth embodiment.

FIG. 46 is an explanatory drawing of the EL display device according to the fourteenth embodiment.

FIG. 47 is an explanatory drawing of the EL display device according to the fourteenth embodiment.

FIGS. 48A and 48B are explanatory drawings of an EL display device according to a seventeenth embodiment.

FIGS. 49A1 to 49C3 are explanatory drawings of the EL display device according to the seventeenth embodiment.

FIG. 50 is a drawing showing a personal digital assistant.

FIG. 51 is a drawing of a video camera.

FIG. 52 is a drawing of a digital camera.

FIG. 53 is an explanatory drawing of the EL display device according to the thirteenth embodiment.

FIG. 54 is an explanatory drawing of a modification.

### DETAILED DESCRIPTION OF THE INVENTION

Referring now to the drawings, an EL display device according to embodiments of the invention will be described.

### First Embodiment

An EL display device according to a first embodiment will be described.

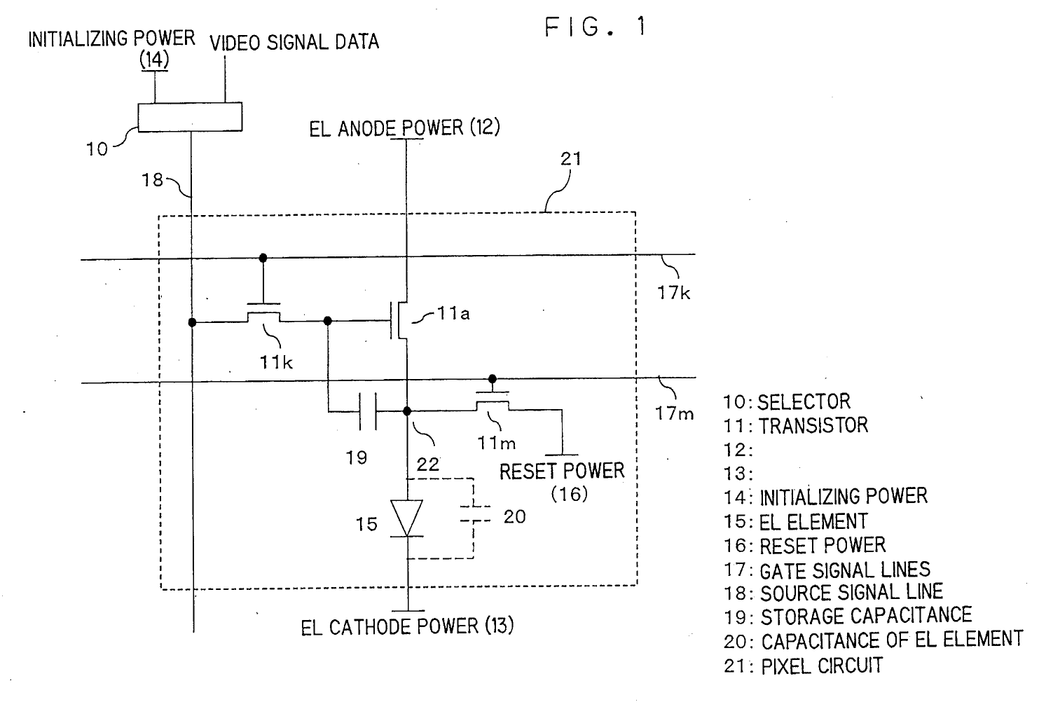

FIG. 1 shows a configuration of a pixel circuit 21 in the first embodiment.

In FIG. 1, a power to be connected to a drain electrode of a drive transistor 11a is fixed to an EL anode power 12, so that a switching unit 62 is not necessary.

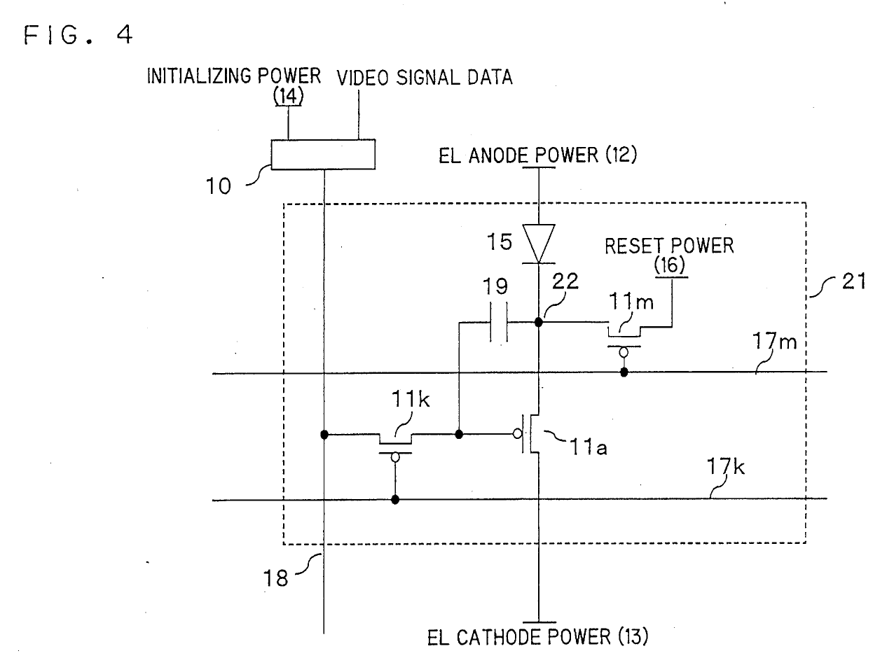

Although the configuration in FIG. 1 is an n-type TFT, it may be implemented in a p-type TFT shown in FIG. 4.

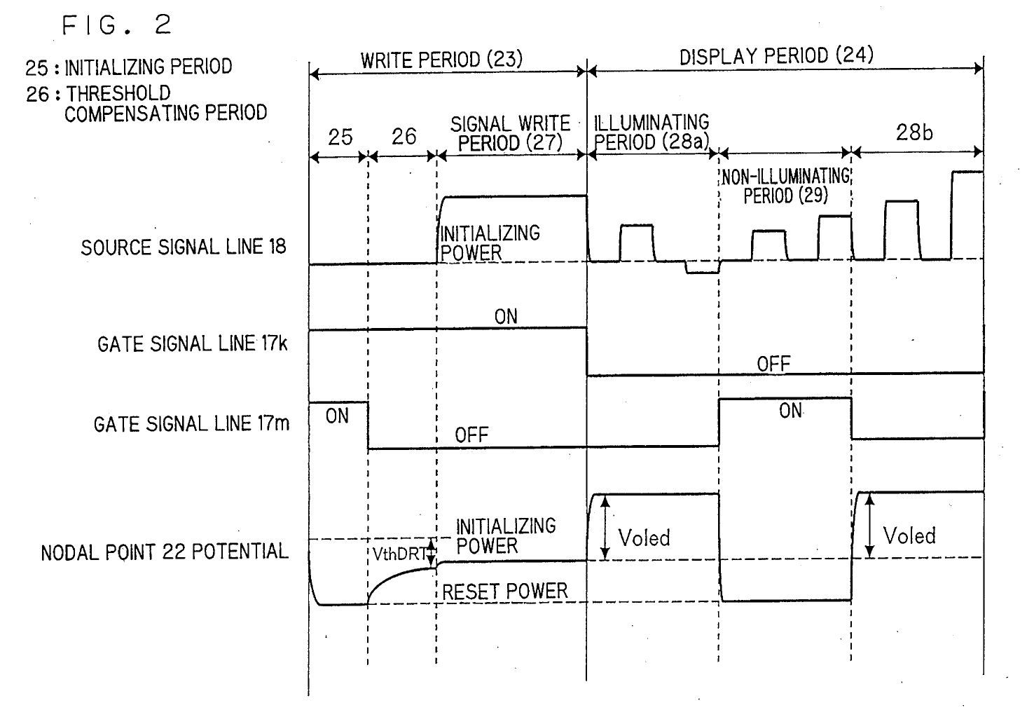

An operation of the circuit in FIG. 1 will be described with a timing chart shown in FIG. 2.

Display is achieved in a write period 23 in which a voltage corresponding to a video signal data transmitted from an outside of the display device is written to the pixel circuit 21 and a display period 24 in which a light is emitted at a predetermined luminance.

(1) Write Period 23

The write period 23 includes an initializing period 25 for erasing video signal data in a previous frame and preparing for writing of a video signal, a threshold compensating period 26 for correcting variations in a threshold voltage of the drive transistor 11a, and a signal write period 27 for writing a voltage corresponding to the video signal to a pixel.

(1-1) Initializing Period 25

In the initializing period 25, a potential of an initializing power 14 is applied to a gate electrode of the drive transistor 11a, and a voltage of a reset power 16 is applied to a source electrode. A potential difference between the initializing power 14 and the reset power 16 is set to achieve a sufficient flow of a drain current of the drive transistor 11a.

(1-2) Threshold Compensating Period 26

In the threshold compensating period 26, a charge corresponding to a source-gate voltage when the drain current of the drive transistor 11a does not flow is stored in a storage capacitance 19. At this time, it is necessary to block the drain current of the drive transistor 11a by causing an EL element 15 to be applied with a reverse bias voltage to bring a transistor 11m as a switch into a non-conducting state. Therefore, in the initializing period 25, it is necessary to supply a voltage lower than a current emission starting voltage (threshold voltage of the EL element) of the EL element 15 from the reset power 16 to at least an EL cathode power 13 as a voltage at a nodal point 22.

Since a source-gate potential difference of the drive transistor 11a when the threshold compensating period 26 is ended is less than when the threshold compensating period 26 is started, the voltage at the nodal point 22 might rise. Therefore, it is necessary to prevent a current from flowing to the EL element 15 when a correction of the threshold value is ended and a threshold voltage (VthDRT) of the drive transistor 11a is stored in the storage capacitance 19, and it is necessary to set a potential difference between voltage values of the initializing power 14 and the EL cathode power 13 to a value smaller than a sum of a threshold voltage (VthEL) of the EL element 15 and the threshold voltage (VthDRT).

Accordingly, a potential at the nodal point 22 is set to a voltage lower than the initializing power 14 by an amount corresponding to the threshold voltage (VthDRT) when the threshold compensating period 26 is ended as shown in FIG. 2. Since the threshold voltage (VthDRT) varies according to characteristics of the drive transistor 11a of the pixel circuit 21, the potential at the nodal point 22 is determined according to characteristic variations of the drive transistor 11a, so that a uniform display is achieved irrespective of the characteristic variations of the drive transistor 11a.

(1-3) Signal Write Period 27

Subsequently, in the signal write period 27, video signal data is inputted to a source signal line 18.

A gate potential of the drive transistor 11a is the same potential as a voltage of the video signal data. The voltage at the nodal point 22 is determined by a capacitance ratio between the storage capacitance 19 and a capacitance 20 of the EL element 15, and the source-gate voltage of the drive transistor 11a is determined by the capacitance ratio and the amount of change of the voltage from the initializing power 14 to the video signal data.

Since the storage capacitance and the capacitance 20 of the EL element always have a constant value if the display device is determined, the source-gate voltage of the drive transistor 11a is determined by the voltage of the video signal data, so that display according to the gradation is achieved.

(2) Display Period 24

Subsequently, in the display period 24, assuming that the transistor 11m is in the non-conducting state, the drive transistor 11a supplies the drain current to the EL element 15 according to a charge in the storage capacitance 19 written in the write period 23, so that the EL element 15 emits light.

When the transistor 11m is brought into a conducting state, a potential difference between both ends of the EL element 15 does not exceed the threshold voltage of the EL element and hence the current does not flow to the EL element. Therefore, a non-illuminating state is assumed irrespective of the charge of the storage capacitance 19, and a non-illuminating period 29 is achieved.

The charge in the storage capacitance 19 is maintained to the charge written in the write period 23 even during the non-illuminating period 29. Therefore, even when an illuminating period 28b is provided, the EL element 15 emits light at the predetermined luminance if it is before entering the write period 23 again.

(3) Modification of Operation

It is possible to perform an illumination and a non-illumination repeatedly during one frame. When the illuminating period is provided by a plurality of times, there is an advantage such that a flicker is reduced.

In the non-illuminating period 29, when the voltage of the reset power 16 is lower than that of the EL cathode power 13, the reverse bias voltage is applied to the EL element 15, so that a lifetime of the EL element may be elongated.

The write period 23 in which the pixel circuits 21 are arranged in a matrix pattern corresponds to one horizontal scan period. However, when the one horizontal scan period is short, a sufficient time cannot be prepared for a threshold compensating operation, so that the characteristic variations of the drive transistor might not be sufficiently compensated.

(4) Divided Writing

It is also possible to implement the write period 23 by dividing the same into a plurality of scan periods.

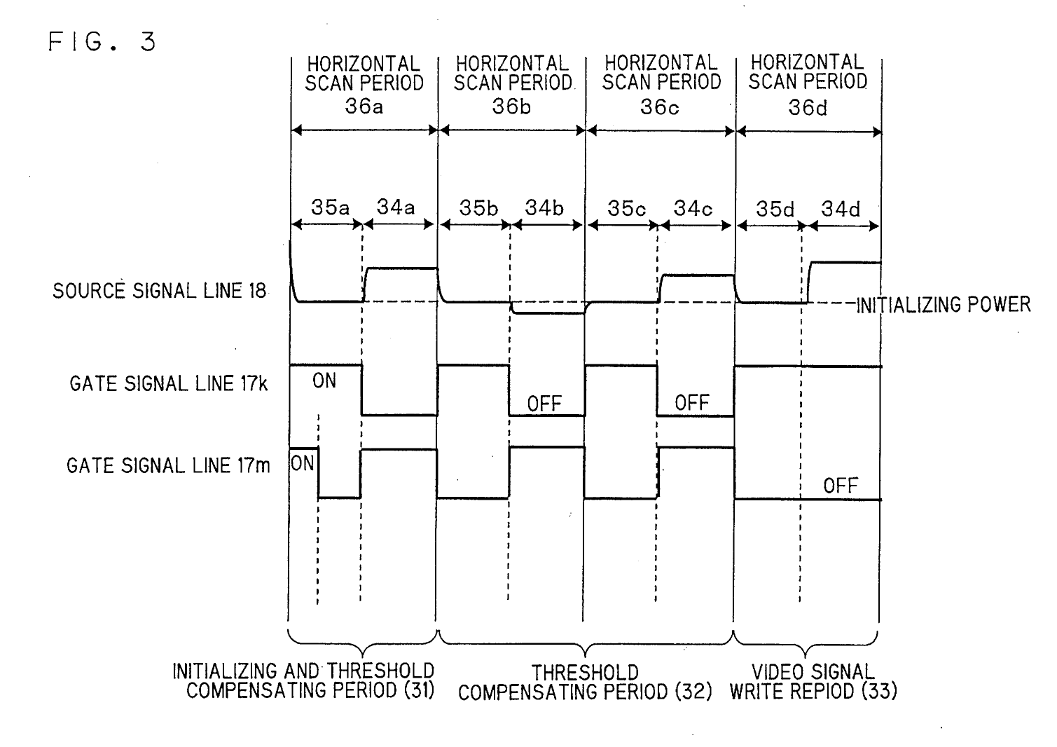

An operation to perform writing in a plurality of the horizontal scan periods using a period 35 in which the initializing power 14 is applied to the source signal line 18 from among the horizontal scan periods before a desired video signal is inputted from the source signal line 18 is shown in FIG. 3.

An initialization and a threshold compensation are implemented in a first horizontal scan period 36a. The initializing operation includes only writing the initializing power 14 and the reset power 16 into the pixel, and hence it may be implemented in approximately 2 to 5 μs. An example shown in FIG. 3 is an example in which the period 35 exists for not shorter than 5 μs, and the threshold compensating operation may be implemented during the remaining period. When the length of the period 35 is not sufficient for initialization, the initialization may be performed for a plurality of periods, or a configuration which includes only the initializing period is also applicable.

The threshold compensating period is performed across a plurality of periods. Three horizontal scan periods including periods 31 and 32 will be exemplified for description. Any number of the horizontal scan periods may be applicable as long as it is two or more.

In a case where the threshold compensating operation is not completed in a period 35a, a switch 11k is brought into the non-conducting state by a gate signal line 17k so that a gradation different from a predetermined gradation is not applied to the pixel circuit 21 in a period 34 where the video signal is written in the source signal line 18. In order to prevent a gate voltage of the drive transistor 11a from rising and hence causing the current to flow to the EL element 15, the transistor 11m is brought into the conducting state in order to set the voltage at the nodal point 22 to a reset voltage by the reset power 16. The charge to be stored in the storage capacitance 19 does not fluctuate in the period 34.

When the initializing power 14 is applied again to the source signal line 18, the threshold compensating operation is performed again as shown in a period 35b. When the period 35b is started, a source-drain voltage of the drive transistor 11a is in the same state as a final state in the period 35a, and the threshold compensating operation is implemented until the video signal is applied.

The threshold compensating operation is repeatedly implemented (36b, 36c) until the threshold compensating operation is completed.

The threshold compensating operation may be implemented until an initializing power application period 35d immediately before a horizontal scan period 36d in which the video signal corresponding to the pixel circuit 21 is inputted. In the example shown in FIG. 3, the threshold compensating operation is implemented for the periods from 35a to 35d (about four times the case shown in FIG. 2), so that a charging and discharging of the storage capacitance 19 and the capacitance 20 of the EL element are achieved even with a small drain current of the drive transistor 11a.

(5) Reduction of Power Consumption

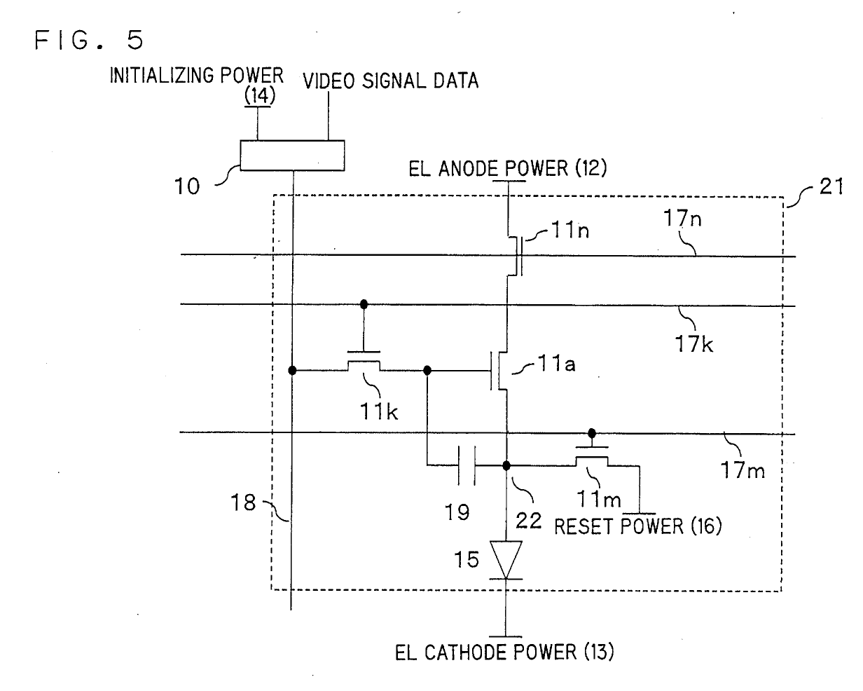

In the non-illuminating period 29, a current flowing between the EL anode power 12 and the reset power 16 is a current unnecessary for display. In order to reduce the power consumption, a configuration in which a switch 11n as shown in FIG. 5 is added may be employed so as to prevent a current from flowing in the non-illuminating period 29.

(6) Light Resonator

The EL element 15 used in the first embodiment is provided with a function as a light resonator, and is configured to take light having a wavelength required as the display device effectively.

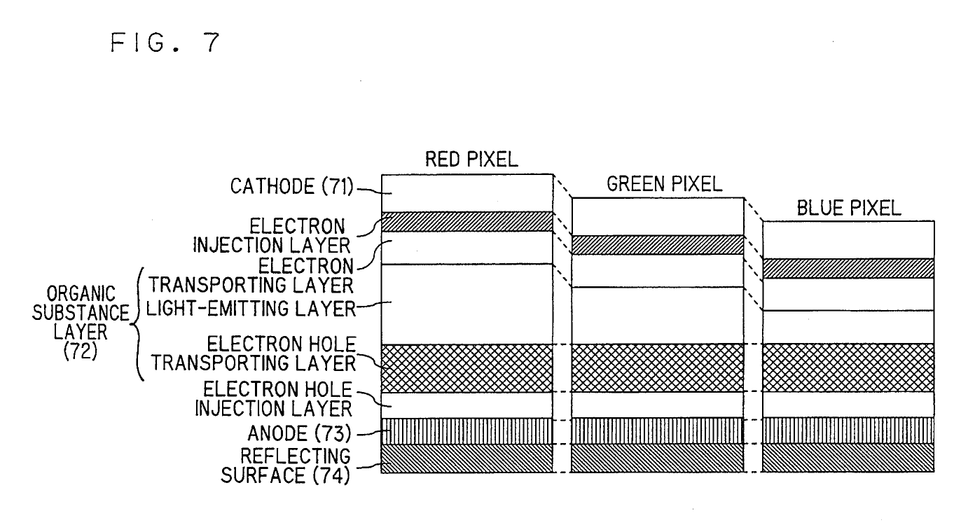

FIG. 7 is a cross-sectional view of the EL element.

When providing the EL element 15 with the function as the light resonator, the optical path length between reflecting surfaces of the light resonator is set to, for example, an integral multiple of a zeroth-order interference mode: a first peak mode (an optical path length in which an intensity of light proceeding in a direction of a normal line demonstrates a maximum value first when the optical path length is increased from zero). For example, in a case of the display device including pixels of blue, green, and red, the above-described optical length in the blue pixels is set to be a range of integral multiples of 66 nm to 87 nm inclusive, the above-described optical length in the green pixels is set to be a range of integral multiples of 87 nm to 113 nm exclusive, and the above-described optical length in the red pixels is set to be a range of integral multiples of 113 nm to 160 nm inclusive.

The optical path length is shortened as much as possible. In other words, it is set to the interference mode of a lower order. Ideally, by setting the zeroth-order interference mode, the thickness of an organic substance layer 72 may be reduced. Therefore, the amount of material used therefor may be reduced. In addition, in this case, optimization of resonance conditions may be facilitated in the pixels of the respective light-emission colors. In addition, a voltage to drive the EL element 15 may be lowered, so that lowering of the power consumption is achieved.

The optical path length described above is varied by changing an index of refraction or a thickness of a layer interposed between the reflecting surfaces of the light resonator. However, in many cases, the index of refraction of the layer cannot be changed freely. For example, the index of refraction of a material used for the organic substance layer 72 and the electrodes is normally from 1.5 to 3.0. Therefore, the above-described optical path length is adjusted normally by the thickness of the layer interposed between the reflecting surfaces of the light resonator. The index of refraction of the material is set considering a chromatic dispersion properties.

The EL element 15 designed in this manner is characterized in that the film thickness of the organic substance layer 72 is thin, and hence the capacitance that the EL element 15 has is increased.

When a capacitance Coled of the EL element 15 is increased, an amplitude of a voltage Vdata of the video signal data may be reduced. A voltage applied to both ends of the storage capacitance 19 (Cst) of the drive transistor 11a is expressed by Coled/(Cst+Coled)×(Vdata−Vrst)+VthDRT. When storage of a larger amount of charge in the storage capacitance 19 is desired to secure a large amount of current, measures such as increasing the value of Vdata, increasing the value of Coled, or decreasing the value of Cst might be taken. When the EL element 15 designed in the zeroth-order interference mode is utilized, the value of Coled is larger than the EL element 15 designed in the interference mode in a higher order, so that the necessity to form an auxiliary capacitance in parallel to the EL element 15 newly due to the fact that the value of Coled is small is eliminated, and hence the circuit structure shown in FIG. 1 may be applied to finer pixels.

Although an example in which a reflecting surface 74 is formed below an anode 73 is described in FIG. 7, it may be formed above a cathode 71, or either the cathode 71 or the anode 73 may be formed of a material having a reflecting property to implement the reflecting surface and the electrode on the same layer. The reflecting surfaces may be formed on the electrodes on both sides.

The sign Vrst designates a voltage of the initializing power 14.

When the capacitance of the EL element 15 is small, the implementation is achieved by forming an additional capacitor arranged in parallel to the EL element 15.

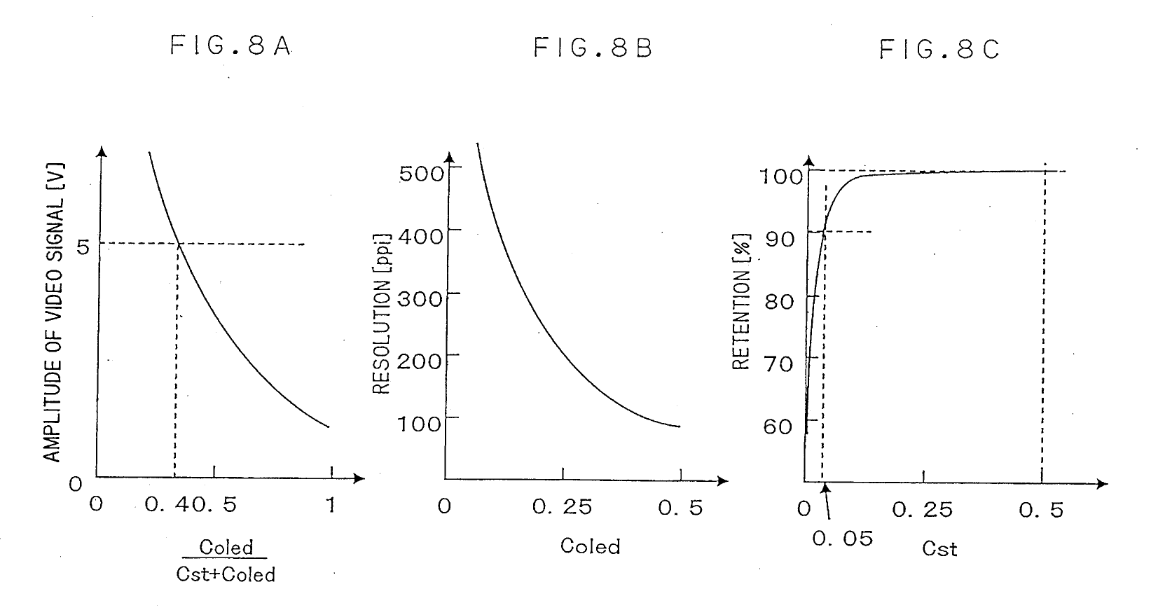

An upper limit of the amplitude of the voltage Vdata is determined by a blocking voltage of a source driver IC which supplies the video signal from the source signal line, and is 5.5 V at the maximum for the source driver IC having a timing controller unit in the source driver IC. Considering fluctuations of a power voltage to be applied to the source driver IC, and the fact that it is difficult to form an amplifier which outputs voltages close to the power voltage and a voltage output performance is poor generally at approximately 0.2 V above and below the power voltage, a range of the voltage which may be used as the voltage Vdata is about 5 V at the maximum. As regards the initializing power 14, when the source signal line is used for the input, input of the voltage out of the range of the blocking voltage of the source driver IC cannot be employed because it has a risk of input of voltages exceeding the blocking voltage into the source driver IC, so that it is at least 0 V. Therefore, in order to minimize the amplitude of the video signal, the value of Coled/(Cst+Coled) is needed to be large. FIG. 8A shows a relation with the amplitude of the video signal. According to FIG. 8A, the value of the Coled/(Cst+Coled) must be 0.4 or higher. Although it is achieved by increasing the value of Coled and decreasing the value of Cst, the maximum value of Coled is determined by the surface area of the pixels (the resolution) as shown in FIG. 8B. Reduction of the value of Cst is limited in order to maintain the voltage written in the write period 23 for one-frame period and, if the voltage cannot be maintained for one-frame period, the flicker caused by varying in current flowing in the EL element 15 between the beginning and the end of the one frame might occur. The ratio of maintenance is preferably 90% or higher and, in order to achieve this value, the value of Cst is needed to be 0.05 or higher.

(7) Initializing Power 14

The initializing power 14 is preferably within a rage of the voltage of the video signal applied to the source signal line 18. Although the characteristic variations are compensated when an initializing voltage is applied to the drive transistor 11a, if the gate voltage of the drive transistor 11a is varied by the video signal writing, the drain current of the drive transistor 11a after the video signal writing changes due to the variations in mobility. Therefore, the larger a voltage difference between the initializing power 14 and the video signal becomes, the larger the current variations from pixel to pixel becomes due to the variations after the movement, so that the smaller potential difference is preferable. Therefore, the initializing power 14 is preferably set to a value within a range of the amplitude of the video signal.

In the threshold compensating period, if the time is sufficient, and the threshold compensating operation is performed until the drain current of the drive transistor 11a becomes zero, a black display is achieved by applying the same voltage as that of the initializing power 14 in the video signal write period. However, there is a case where the threshold compensating operation becomes incomplete. When the compensating operation is incomplete, the drain current does not become zero even when the same voltage as that of the initializing power 14 is applied to the video signal, so that the EL element 15 emits light slightly, which lowers a contrast. In order to display a sharp black which is a characteristic of a self-emitting element, a deep black is achieved by reducing the charge amount to be stored in the storage capacitance 19 by inputting a voltage lower than that of the initializing power 14 at the time of the black display as the video signal.

A voltage of the video signal at the time of the black display is preferably a voltage lower than that of the initializing power 14 by approximately 0.2 to 2V.

### Second Embodiment

An EL display device according to a second embodiment will be described.

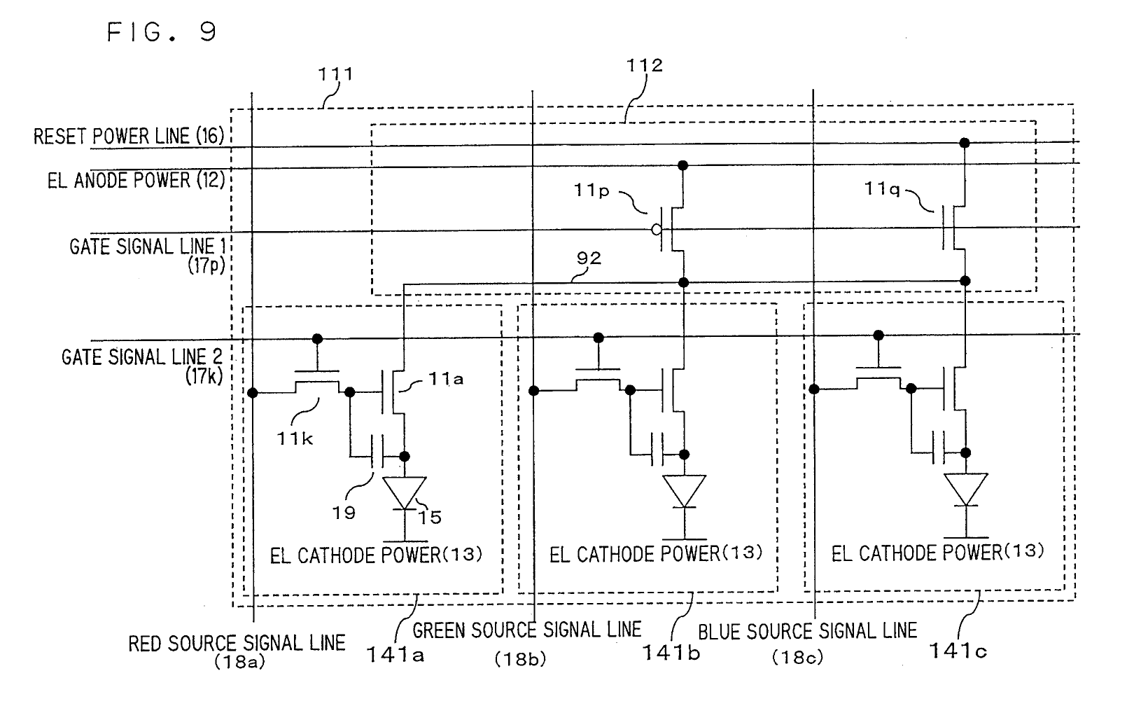

FIG. 9 is a drawing showing a pixel circuit according to the second embodiment.

In FIG. 9, the capacitance arranged in parallel with the EL element 15 is not shown. However, when the capacitance of the EL element 15 does not match the condition in FIGS. 8A to 8C, or when the amplitudes of the video signals of all the colors are to be brought into agreement with each other, the implementation is achieved also in the same manner by adding the EL element 15 in parallel.

(1) Circuit Configuration

A characteristic of FIG. 9 is in that the drain electrodes of the drive transistors 11a among red, green and blue pixels are connected to each other by a wire 92, and the connection from the EL anode power 12 or the reset power 16 to the drive transistor is achieved in common.

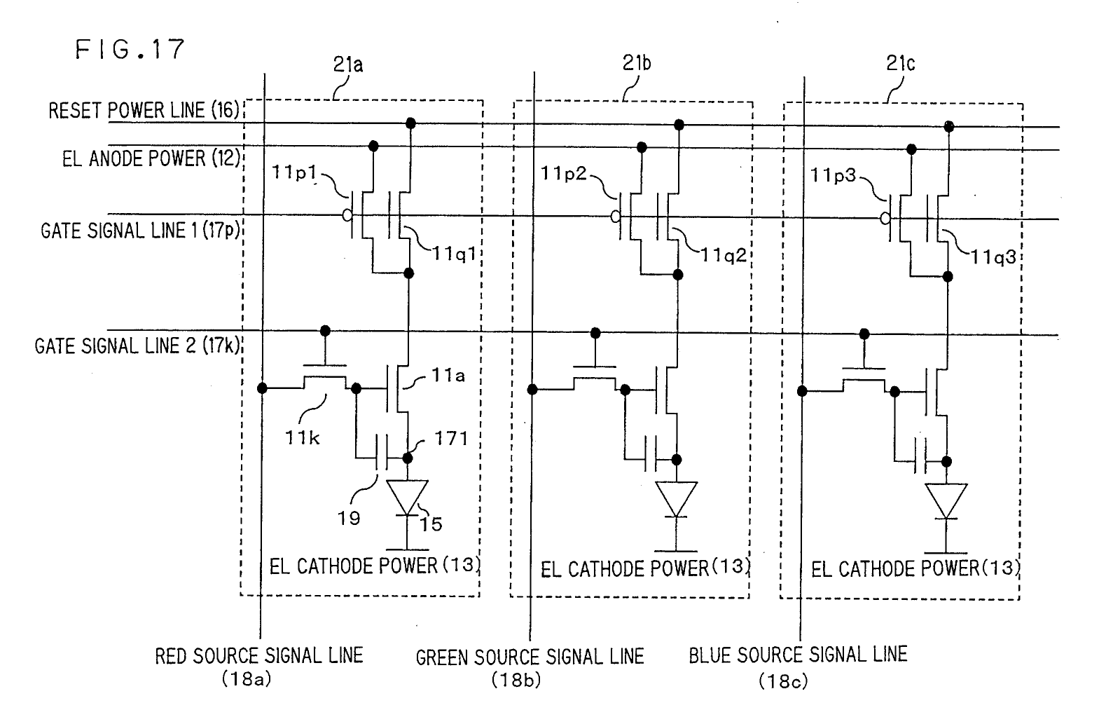

A circuit for supplying a voltage or a current to the drain electrodes of the drive transistors 11a in a pixel region 111 for three pixels is provided in common as indicated by the reference numeral 112, and circuits indicated by the reference numeral 141 for storing gradation data for the respective pixels are formed individually, the circuit scale for the three pixels is small in comparison with a case in FIG. 17 in which the circuit portion indicated by 112 is provided for the each pixel, so that the implementation is achieved even with a smaller pixel surface area.

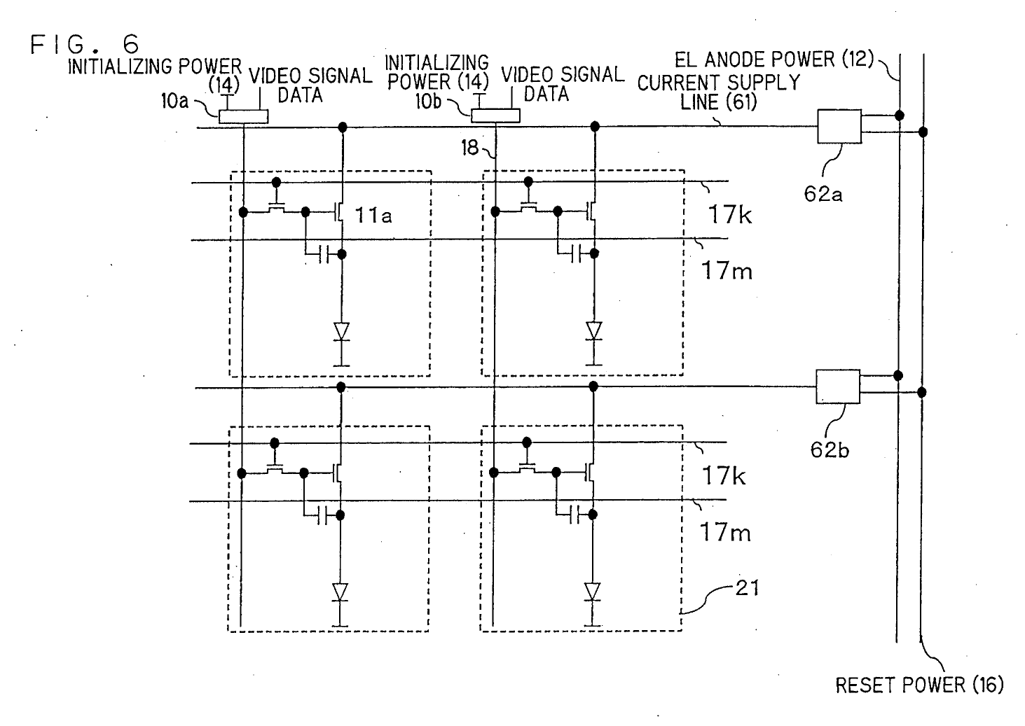

As regards the circuit configuration shown in FIG. 6, two transistors are increased for the three pixels, and hence the circuit by itself is upsized. However, the switching unit 62 is not needed, so that the frame may be downsized.

(2) Operation

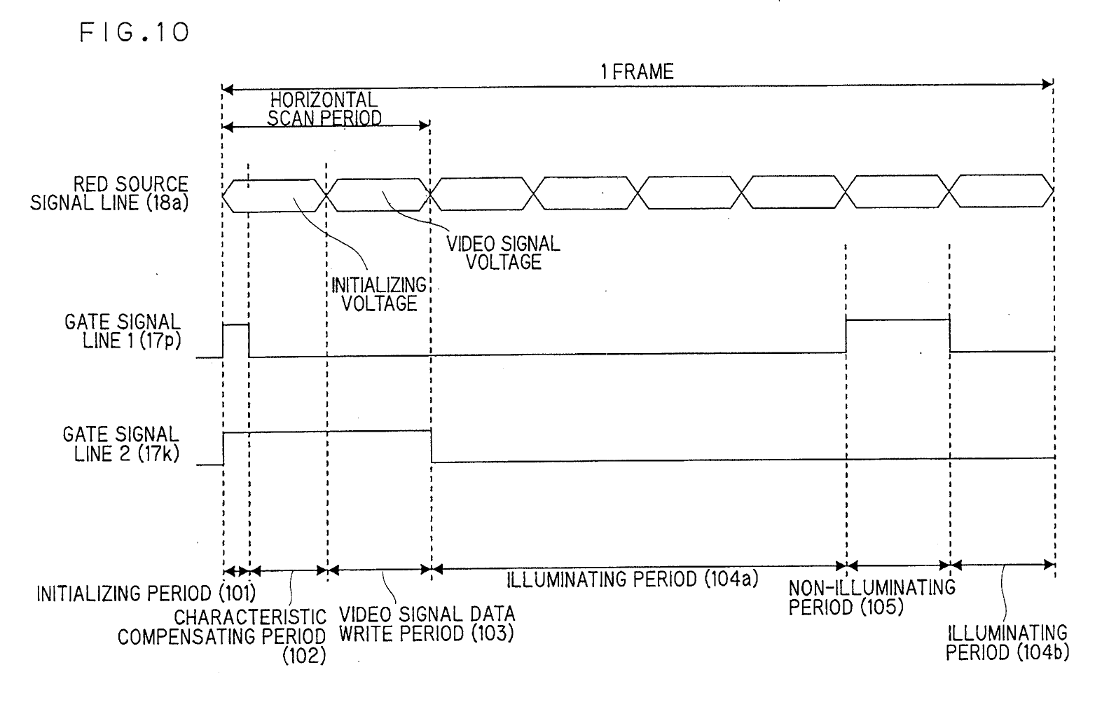

The operation in FIG. 9 will be described with a timing chart shown in FIG. 10.

In an initializing period 101, the charge stored in the interior of the pixel is initialized and, simultaneously, a large voltage is applied between the source and the gate of the drive transistor 11a for compensating the threshold value. In order to do so, the gate signal lines 17 are activated and the initializing power 14 and the reset power 16 are applied to the interior of the pixel. The initializing power 14 is applied to the gate electrode of the drive transistor 11a via the source signal line, and the reset power 16 is applied to the drain electrode of the drive transistor 11a via a switching transistor (hereinafter, referred to as a switch) 11q and the wire 92. The voltages of the initializing power 14 and the reset power 16 to be applied are the same as those in the configuration shown in FIG. 1.

Subsequently, in the threshold compensating period (referred to as a characteristic compensating period in the drawing) 102, a drain current for compensating the characteristic of the drive transistor 11a is supplied from the EL anode power 12 via a switch 11p.

The initializing power 14 is applied to the gate electrode of the drive transistor 11a so as to avoid an application of a normal bias to the EL element 15.

Subsequently, by applying the video signal data corresponding to the respective pixels by the source signal lines 18, a charge corresponding to the gradation and the variations of the threshold voltage of the driving transistor 11a is applied to the storage capacitance 19, so that the writing is completed.

In the illuminating period 104, the switch 11k is brought into the non-conducting state, and the switch 11p is brought into the conducting state, whereby a current is supplied from the EL anode power 12 to the EL element 15.

(3) Advantages

According to the second embodiment shown in FIG. 9, the switch 11p may simply have a channel size sufficient for supplying the current corresponding to the three pixels, the channel width may be 1/100 or smaller in comparison with the switch of the switching unit 62 for supplying a current for all the pixels in one row, so that the implementation with a small circuit is achieved.

Since the three times current is necessary, approximately three times channel width is necessary in comparison with the switch 11p in FIG. 17. However, the channel width is not more than 20 μm and hence an advantage of reduction of a contact surface area by the reduction of the switch 11p is more significant, and the increase of the channel size of the switch 11p does not affect much.

(4) Modification

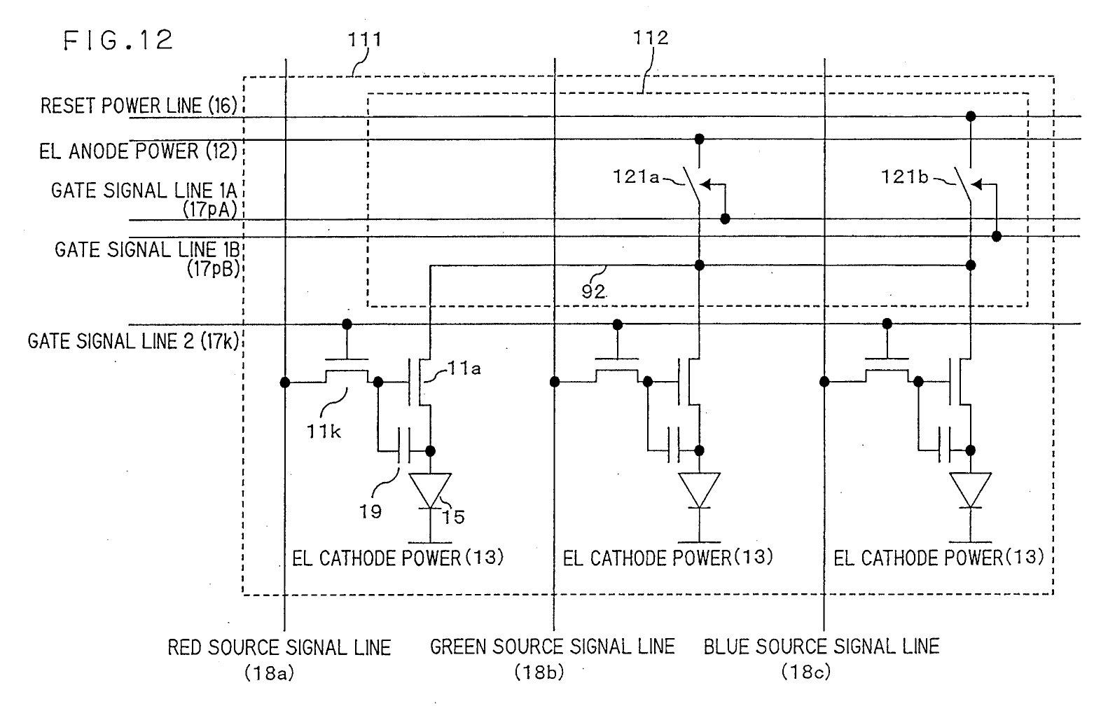

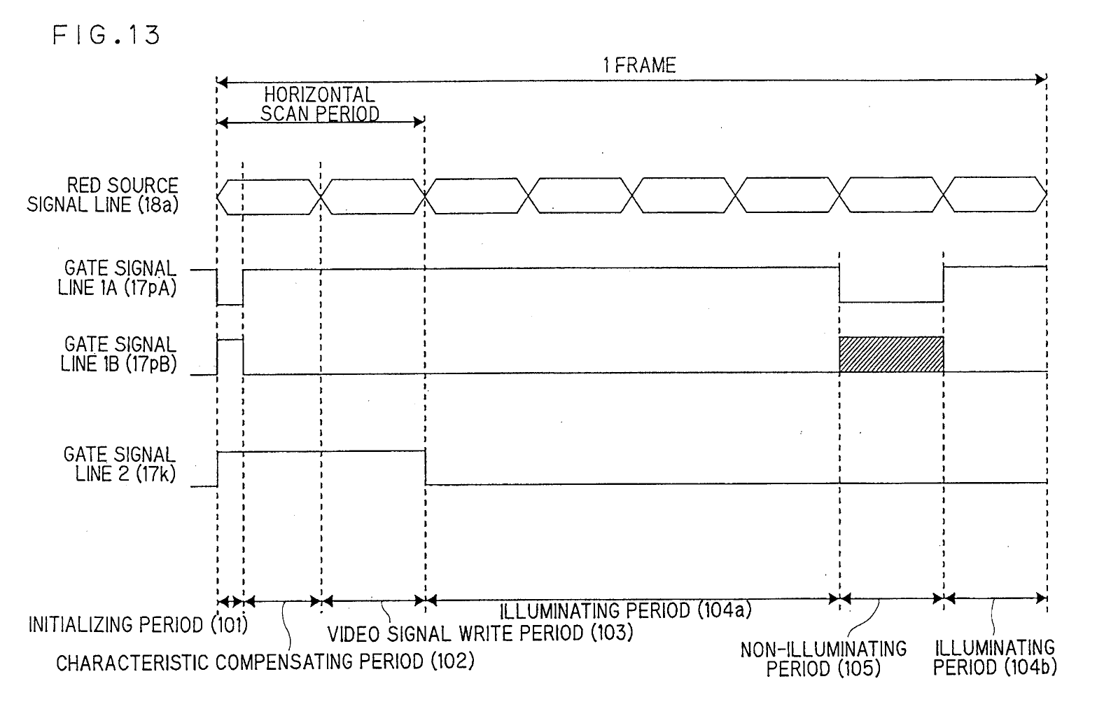

Although the switch 11p and the switch 11q are operated with one gate signal line 1 (17p) in the description in conjunction with FIG. 9, a switch for a reset power and a switch for supplying the current to the EL element may be operated individually as shown in FIG. 12. In this case, a timing chart shown in FIG. 13 is applied. When controlling individually, the number of gate signal lines is increased, and the layout surface area of the circuit is increased. However, avoidance of the problem of the simultaneous ON at a point of change of the operations of the switch 11p and the switch 11q is possible, and avoidance of useless flow of the current is possible by turning all switches 121 OFF in a non-illuminating period 105.

There is also a method of equalizing the number of transistors per pixel because a layout operation is facilitated when employing commonality of the circuit layout for all the pixels as much as possible.

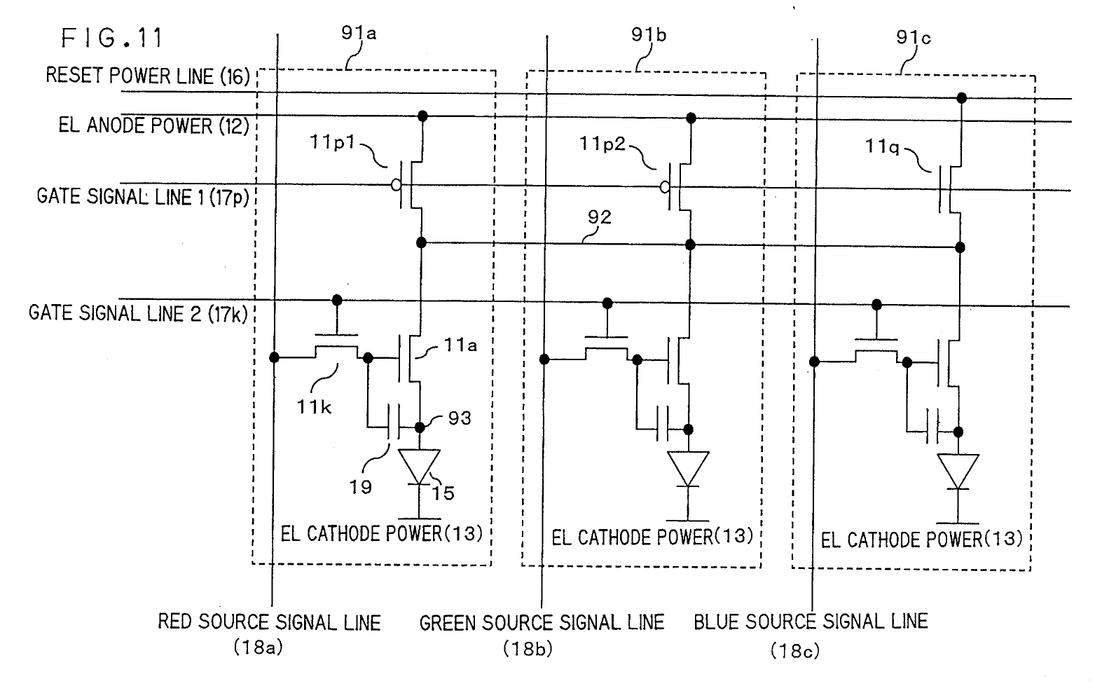

As shown in FIG. 11, the number of the switches 11p is increased and three twitches are arranged for the three pixels. Although it is preferable to arrange a large number of switches 11p because the switch 11p is able to flow a large amount of current, if a large number of switches 11q is necessary for resetting in view of mobility, easiness of fabrication or process rules, arrangement of two switches 11q and one switch 11p is applicable.

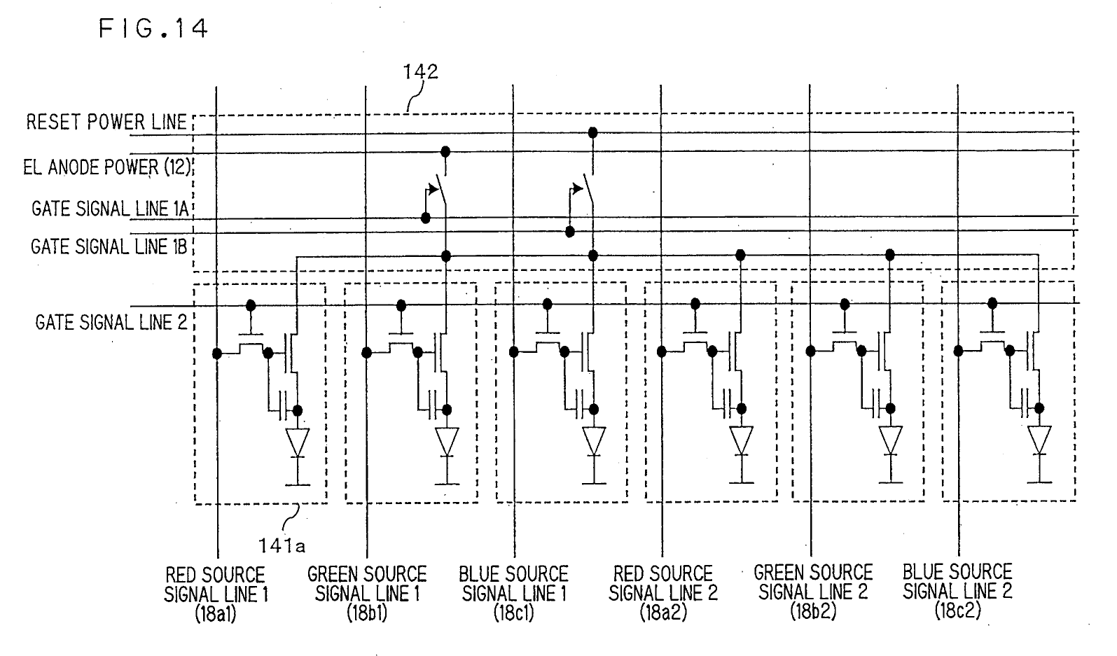

In FIG. 9, the example in which the switch is used in common for the three pixels as indicated by the reference numeral 112 has been described. However, the implementation is also achieved in the same manner with a configuration in which the switch is used in common for six pixels as indicated by the reference numeral 142 in FIG. 14. In the same manner, assuming n represents integers of two or larger, the switch may be effectively used in common for n pixels.

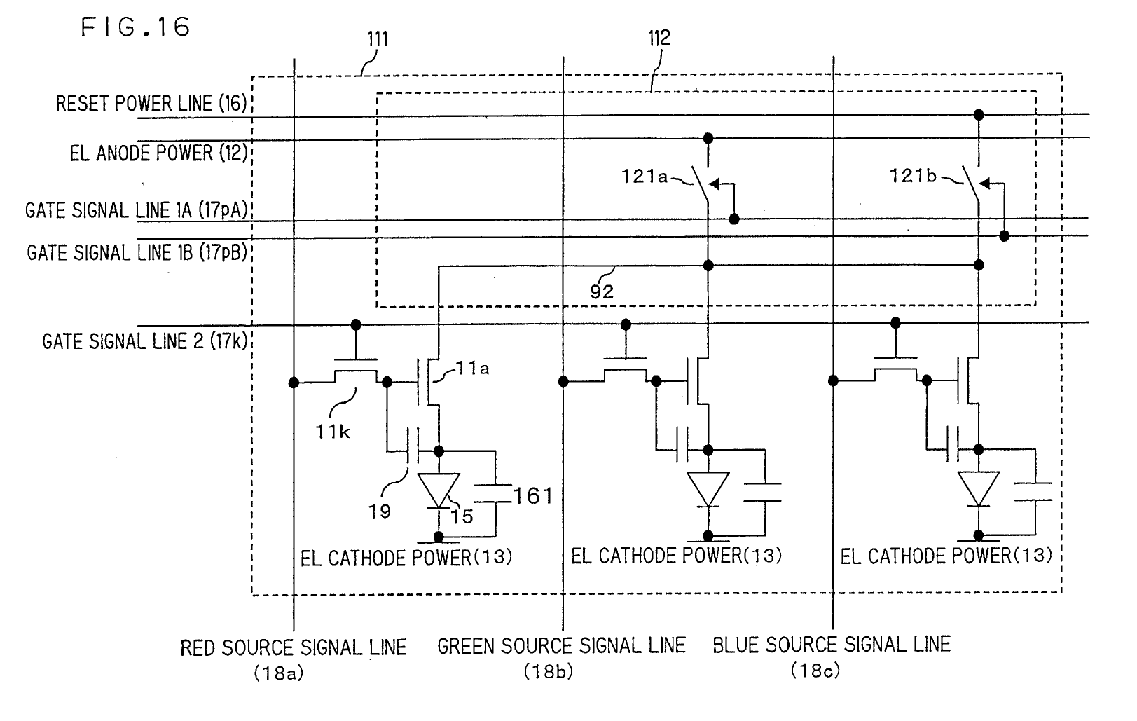

As shown in FIG. 16, it is also possible to realize the display device being less subject to a voltage output deviation by adding capacitances 161 in parallel to the EL elements 15 to reduce the amplitude of a gradation voltage, or setting the amplitude of the voltage of the source driver to the same value to reduce the ratio of increase of the drain current with respect to the gate voltage of the drive transistors 11a and increase the potential difference per gradation, thereby lowering the resolution of a digital-analogue converter of a voltage output unit of the source driver which applies a voltage to the source signal line.

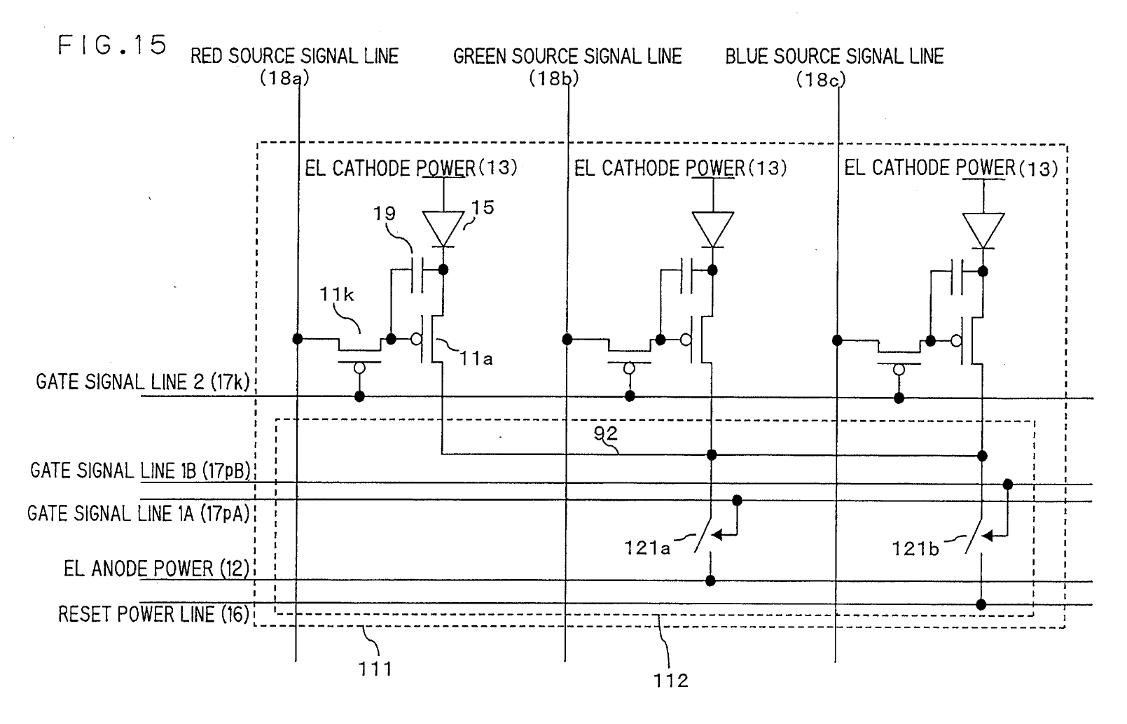

The drive transistor 11a does not necessarily have to be the n-type TFT, and those of the p-type TFT are also implementable by a pixel configuration as shown in FIG. 15 only by reversing the direction of the flow of the current and the high and low of the voltage.

Since the switch 11p and the switch 11q perform the switching operation as explained in the description given above, they are shown as the switches 121 in FIG. 12 and so on. However, since the operations are the same, they may be shown in either way.

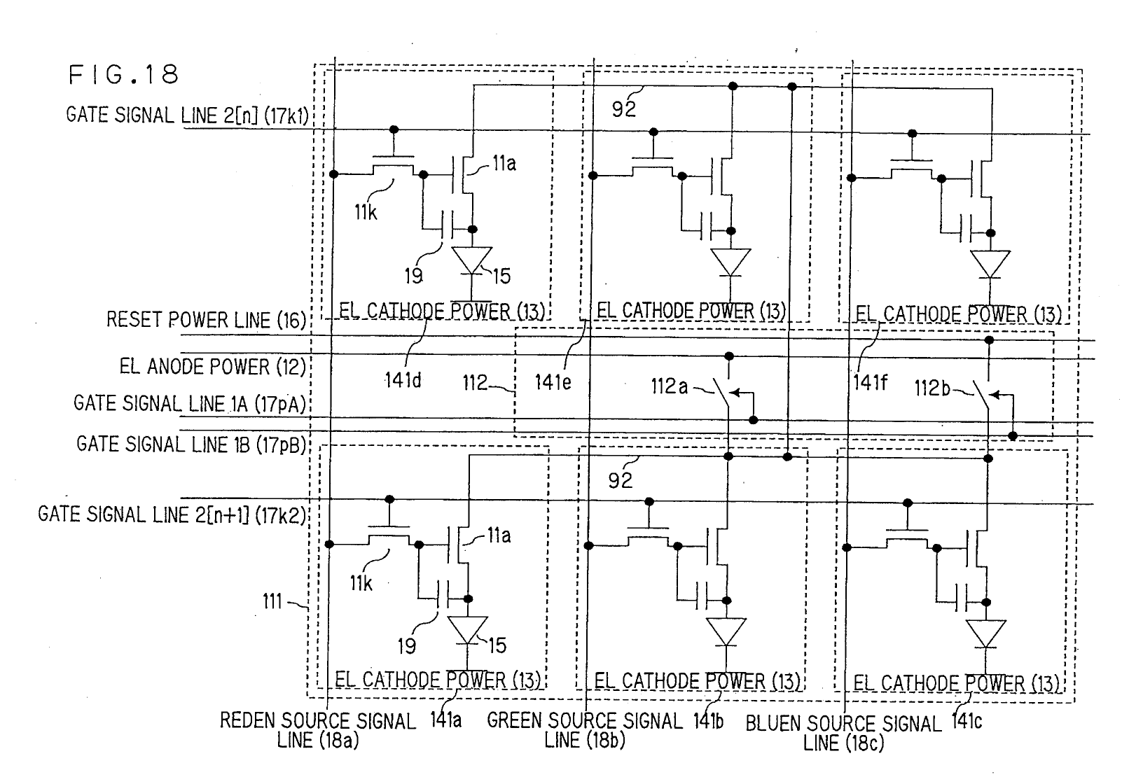

The second embodiment in which the switches 121 are used in common for a plurality of pixels may be implemented for the pixels other than the pixels in the same row. FIG. 18 shows an example in which the switches 121 are used commonly for the three pixels per row in two rows.

The switches in the region 112 are used in common in the pixel region 111 for the circuits of six pixels. It is implementable by connecting the wire 92 to the six pixels including three pixels each for the two rows.

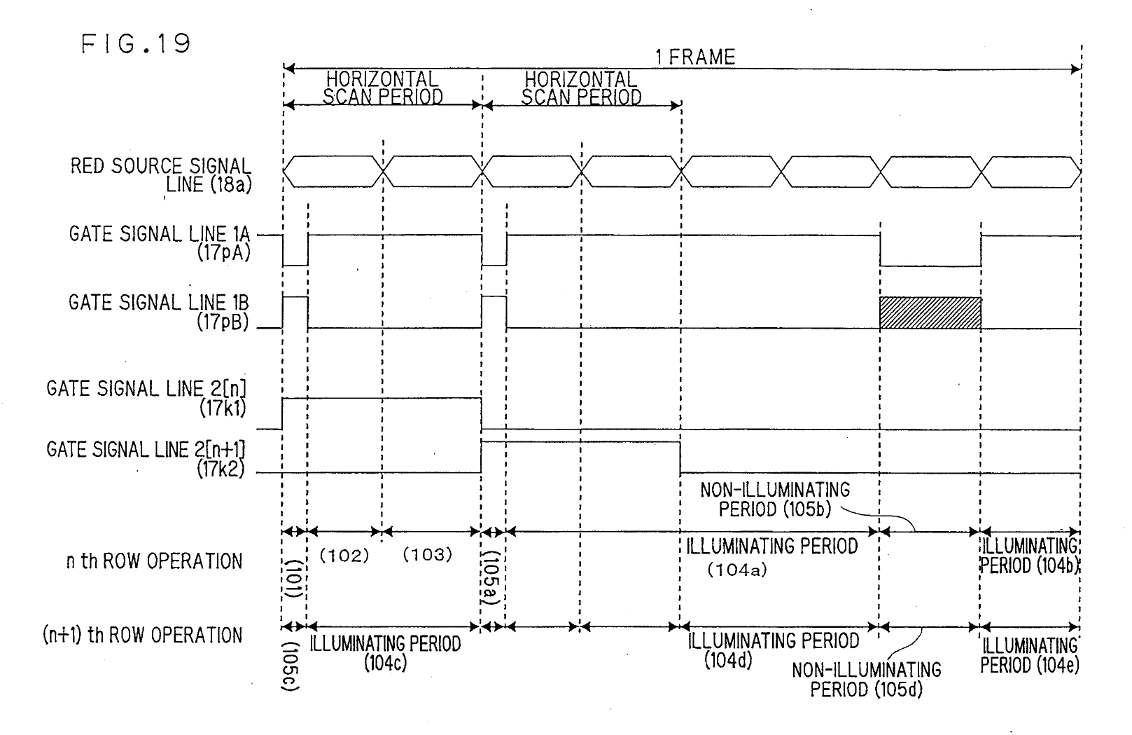

This case is different from the case in which the commonality is implemented for the plurality of pixels in the same row in that if one of the rows is in the initializing period 101 as an operation waveform shown in FIG. 19, the other row is in the non-illuminating period 105 since the power applied to the drain electrodes of the drive transistors 11a is common for the two rows, and in that if the non-illuminating period 105 is provided by the operation of a switch 121a, the operations in the two rows are performed at the same timing.

### Third Embodiment

An EL display device according to a third embodiment will be described.

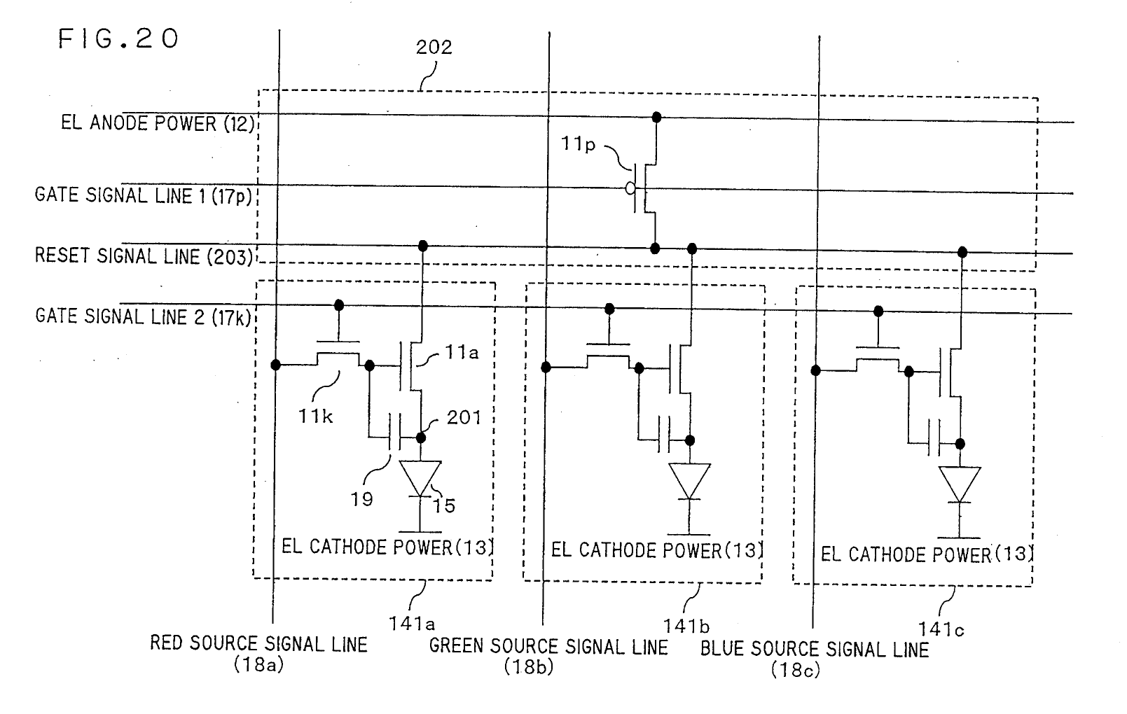

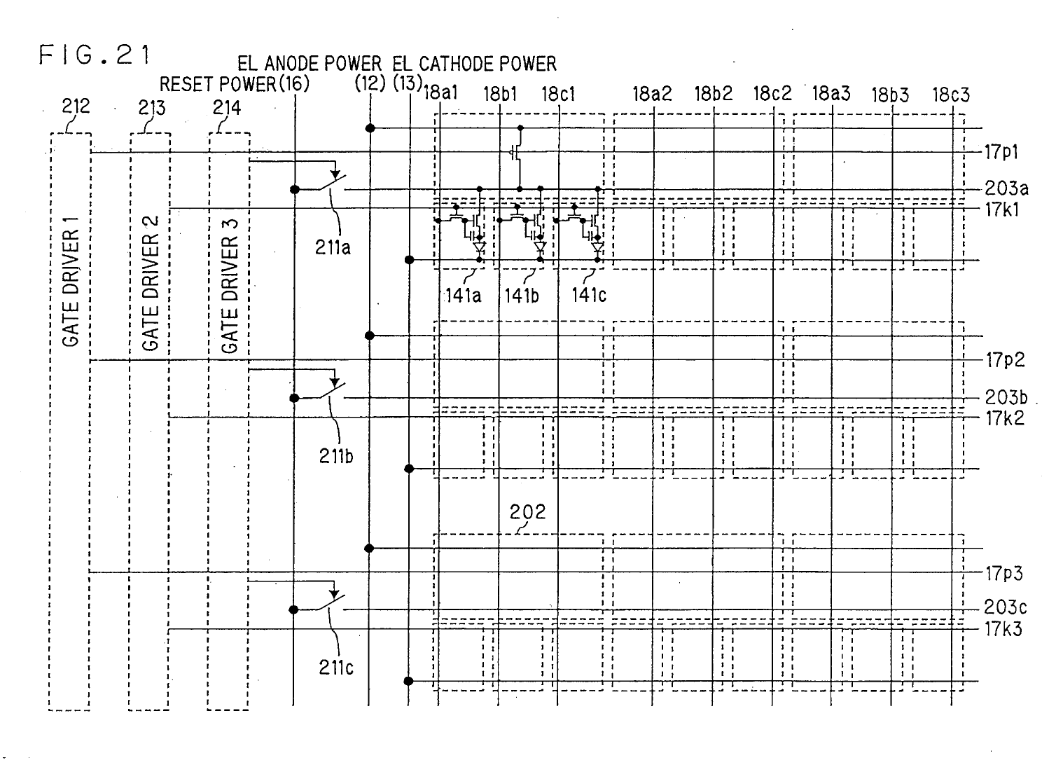

The third embodiment is shown in FIG. 20 and FIG. 21.

(1) Configuration

In contrast to the configuration shown in FIG. 9 according to the second embodiment, in the third embodiment, the switch 11q for performing the initializing operation is eliminated from the pixel region, and the switches are integrated into one per row as switches 211.

In this configuration, the switching unit 62 for selecting the initializing operation is formed in the periphery in the same manner as the configuration in FIG. 6. However, since a large amount of current does not flow from the reset power 16 to a reset signal line 203 connecting the drain electrodes of the drive transistors 11a in all the pixels in the same row during the initializing operation, the switch 211 may be downsized, so that the display device may be implemented without upsizing the frame significantly.

Also, as regards the reset signal line 203, by performing the layout by using the wire 92 in FIG. 9, the switches 11q may be eliminated without increasing the amount of layout, and the circuit surface area required for one pixel may be reduced.

In contrast to the configuration shown in FIG. 6, the switch 11p for supplying the current to the EL elements 15 is formed in the pixel region, and one such the switch 11p is provided per three pixels, for example, as indicated by the reference numeral 202. Even when the channel surface is three times, by configuring the switch with the one switch 11p, the contact surface area or a wiring surface area may be reduced in comparison with the configuration employing the three switches 11p, so that the circuit surface area corresponding to the region 202 is reduced.

Accordingly, the display is achieved with a further smaller circuit scale in comparison with the configuration shown in FIG. 9.

(2) Operation

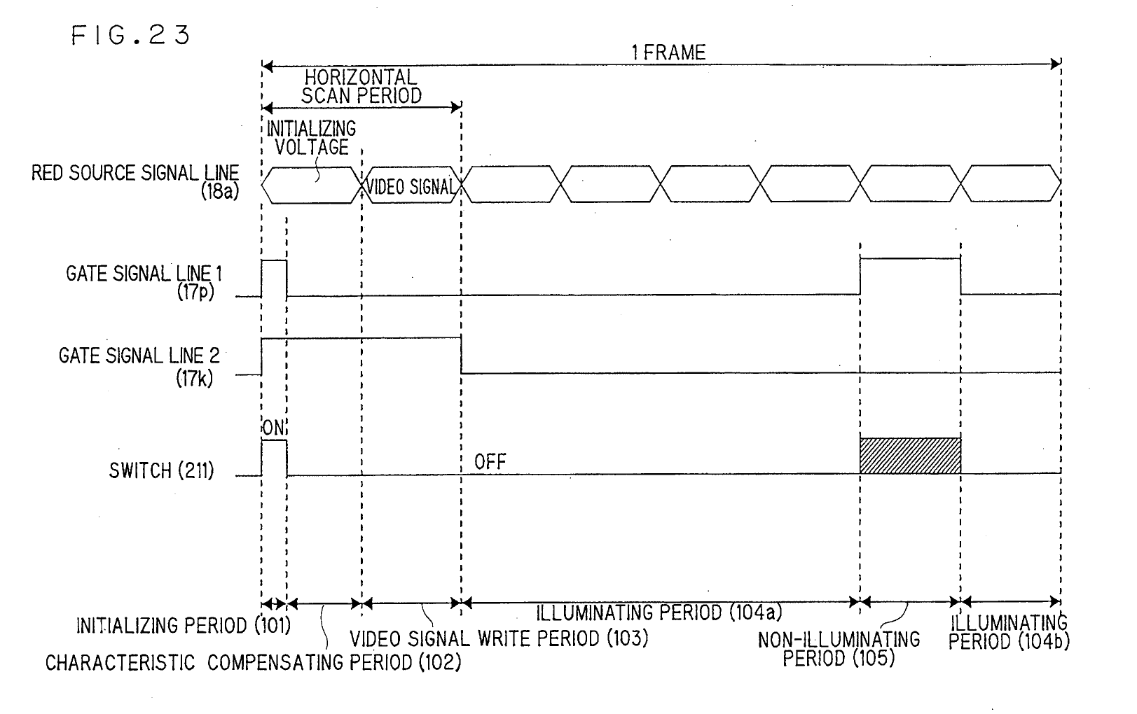

The operation of the third embodiment is shown in FIG. 23. By operating the switch 211 corresponding to the operation of the gate signal line 1, the operation of the pixel circuit which is the same as those described above is achieved, and the display according to the variations of the threshold voltage of the drive transistor 11a and the gradation is achieved.

(3) Modification

Although an example in which the switches 11p and the switches 211 are controlled by the different gate drivers is shown in FIG. 21, if the switches 211 are operated at a high level in the non-illuminating period 105 in FIG. 23, the control by the same gate signal line 1 is possible, and a gate driver 1 (212) and a gate driver 3 (214) may be integrally operated into a one gate driver.

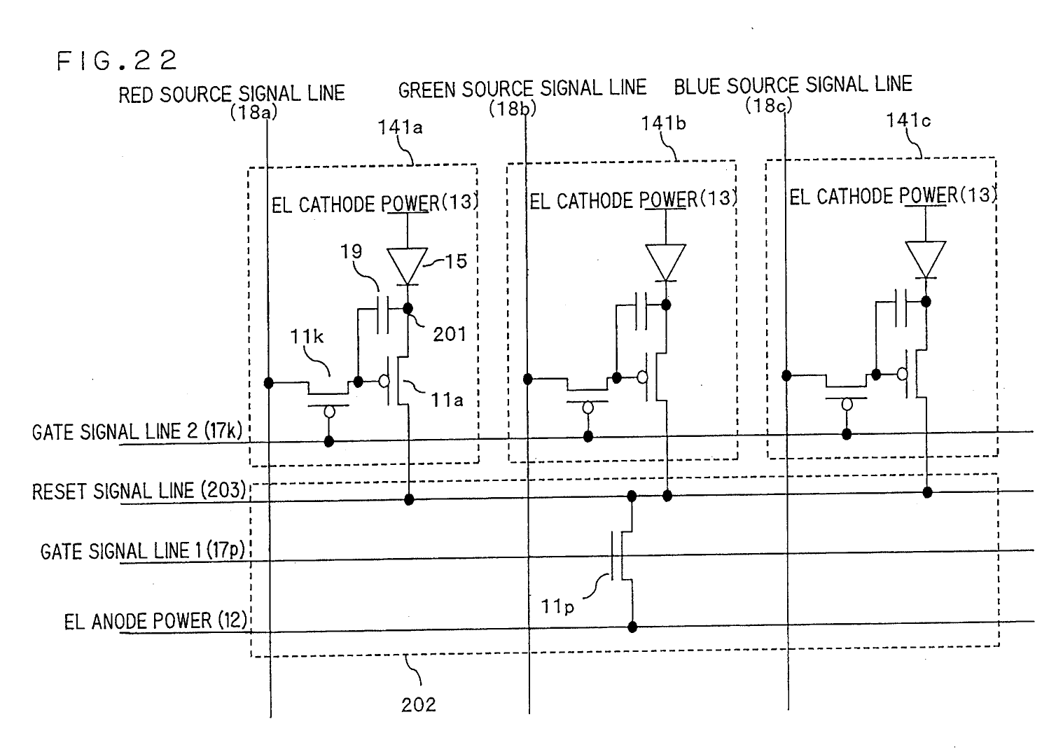

When the drive transistor 11a is the p-type TFT, the pixels in FIG. 22 may be formed instead of those in FIG. 20.

The switches 11p do not have to be provided one for three pixels, and the implementation is achieved also in the same manner by providing one for given n pixels. The value “n” may be determined from the amount of current flowing in one switch 11p and the layout space allowed in the region 202.

(4) Reduction of Load

When the load of the source signal line 18 is large, and a voltage corresponding to the predetermined gradation cannot be applied to the source signal lines 18 for a short time, it is necessary to elongate a signal write period 103. However, when the signal write period 103 is elongated, the drain current flows in the drive transistor 11a depending on the gradation voltage applied to the gate electrode of the drive transistor 11a, so that the charge is stored in the capacitance component of the EL element 15 by the drain current. When the charge is stored in the EL element 15, a potential of a nodal point 201 is increased and varied so that the voltage applied to the both ends of the storage capacitance 19 is reduced. When the amount of change is large, the pixel emits light at a lower luminance than the predetermined luminance, so that the predetermined luminance is not achieved.

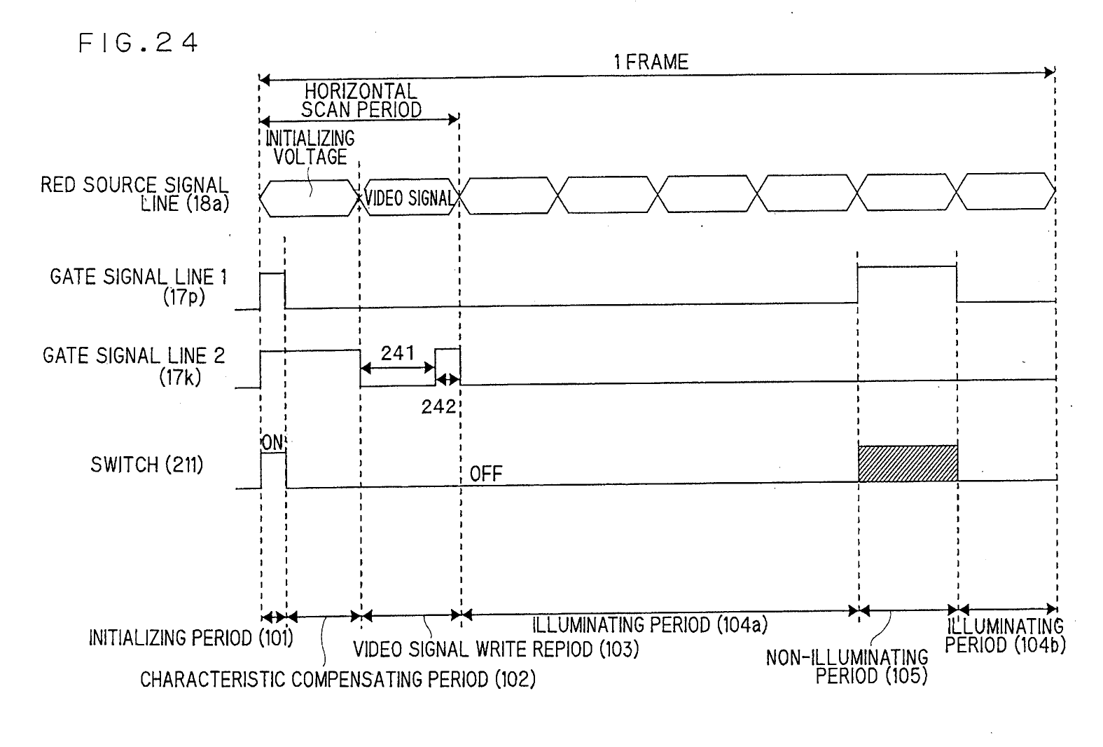

Therefore, the operating method shown in FIG. 24 is employed.

In the signal write period 103, the signal waveform of the gate signal line 2 (17k) is varied, and the switches 11k are brought into the non-conducting state and the video signal from the source driver is written only in the source signal lines 18 in a period 241. When the writing into the source signal lines 18 is done, the switches 11k are brought into the conducting state in a period 242, and the voltage corresponding to the video signal written in the source signal lines 18 is taken into the pixels 141, and the voltage corresponding to the video signal is written to the storage capacitances 19.

In this operating method, what should be done is only to charge the gate electrode of the drive transistor 11a and the storage capacitance 19 from the source signal lines 18, and hence a load is small, and the writing is completed in a short time (1 to 5 μs).

In the method shown in FIG. 20, it is necessary to provide the signal write period 103 for 4 to 20 μs for charging the source signal lines 18. In FIG. 24, the period in which the drain current flows in the drive transistor 11a is 5 μs at the maximum, so that the amount of fluctuations of the potential may be reduced.

### Fourth Embodiment

An EL display device according to a fourth embodiment will be described.

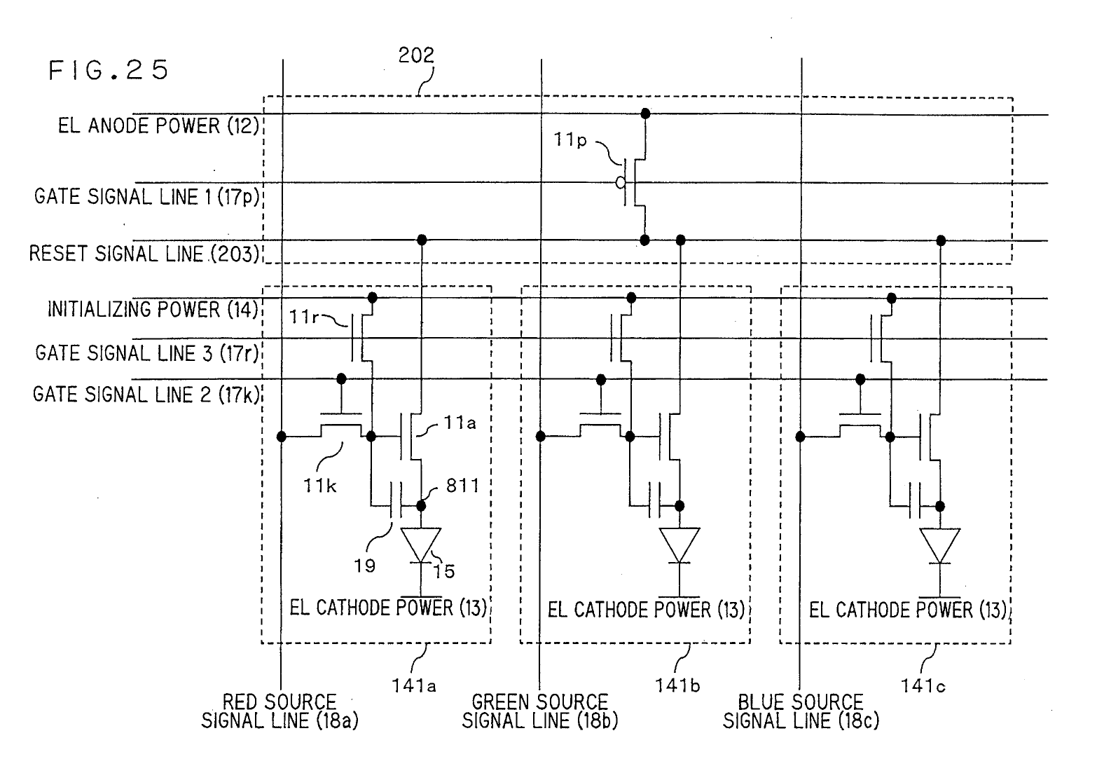

When the number of pixels in the vertical direction is increased, the horizontal scan period is shortened, and hence the sufficient write period of the video signal and the initializing power might not be secured. In order to elongate the write period, a pixel configuration shown in FIG. 25 in which the initializing power is wired separately and the source signal lines 18 transmit a signal corresponding to the video signal is devised.

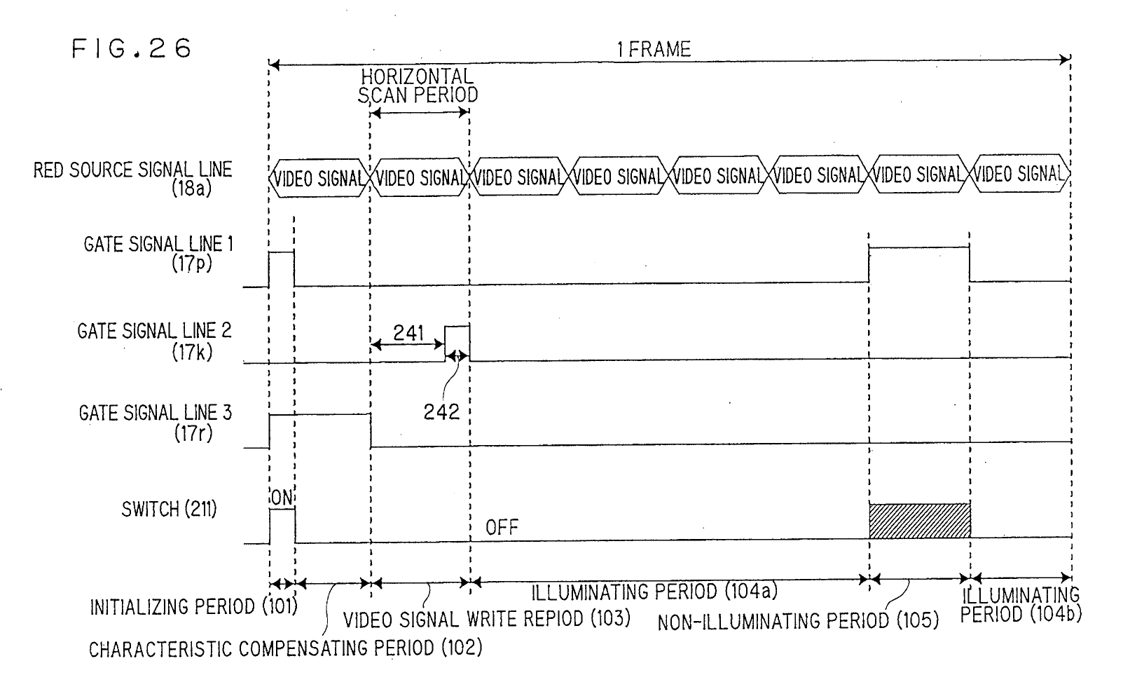

In the configuration in FIG. 25, the initializing power 14 is wired separately, and the initializing voltage is applied to the gate electrode of the drive transistor 11a via switches 11r. A timing of drive is as shown in FIG. 26.

According to the configuration of the pixel circuit in this embodiment, although a wire for the initializing power is provided separately and hence the circuit scale is upsized, it is possible to implement the initialization 101 and the characteristic compensation 102 by the reset signal line and the initializing power 14 in advance in one horizontal scanning period before, implement the vide signal write period 103 when the voltage of the video signal corresponding to the pixel is applied to the source signal lines 18 as shown in FIG. 26. In the example shown in FIG. 26, the voltage of the video signal is written in the pixels only during the period 242 for preventing the reduction of the luminance.

Lowering of the frequency of the source signal line and, according to FIG. 26, the characteristic compensation may be implemented in one horizontal scan period other than the initializing period 101 (approximately 2 to 29 μs), a longer period may be secured advantageously as the threshold compensating period 102 which needs time most.

In a case where all the writing is performed within one horizontal time as shown in FIG. 26, a long time may be secured as the threshold compensating period 102.

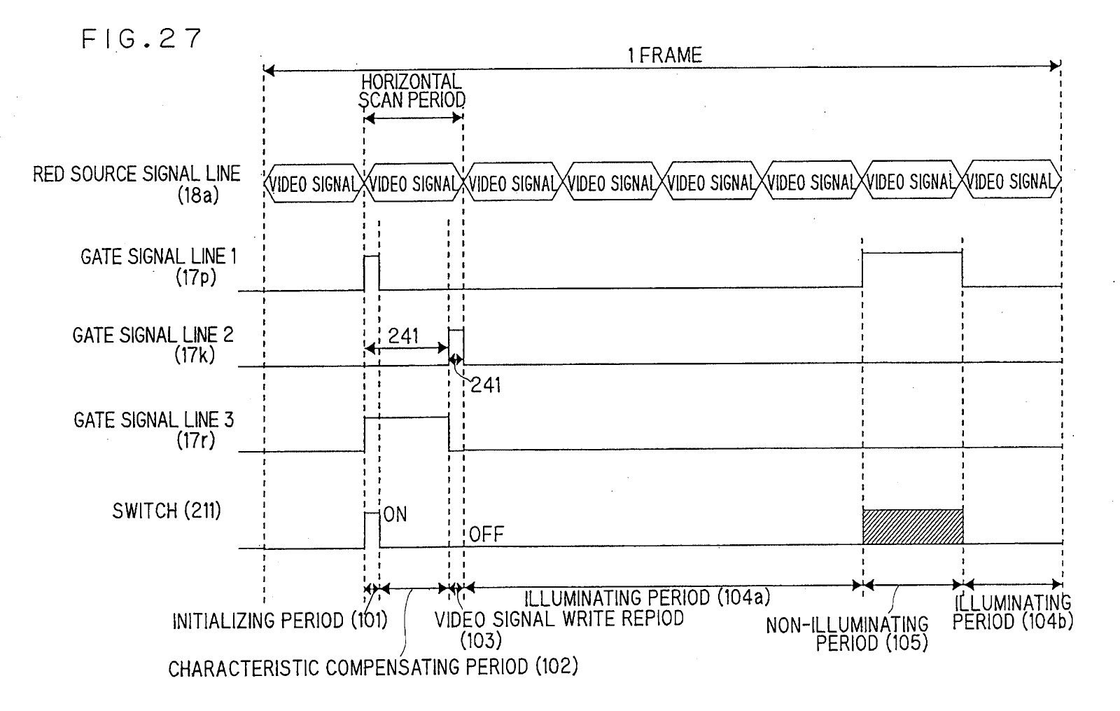

Although it takes time to write the video signal in the source signal lines 18, writing the voltage of the source signal lines 18 in the pixel is achieved in approximately 1 μs. As regards the initializing power 14 as well, since the initializing power is constantly applied, it is not necessary to charge the signal line, and what is necessary is only to vary the gate voltage of the drive transistor 11a. Therefore, the writing is achieved also in approximately 1 μs. As shown in FIG. 27, since the threshold compensating period is secured over the entire period other than 2 μs, so that it has an advantage such that the characteristic compensation of the drive transistor is satisfactorily achieved.

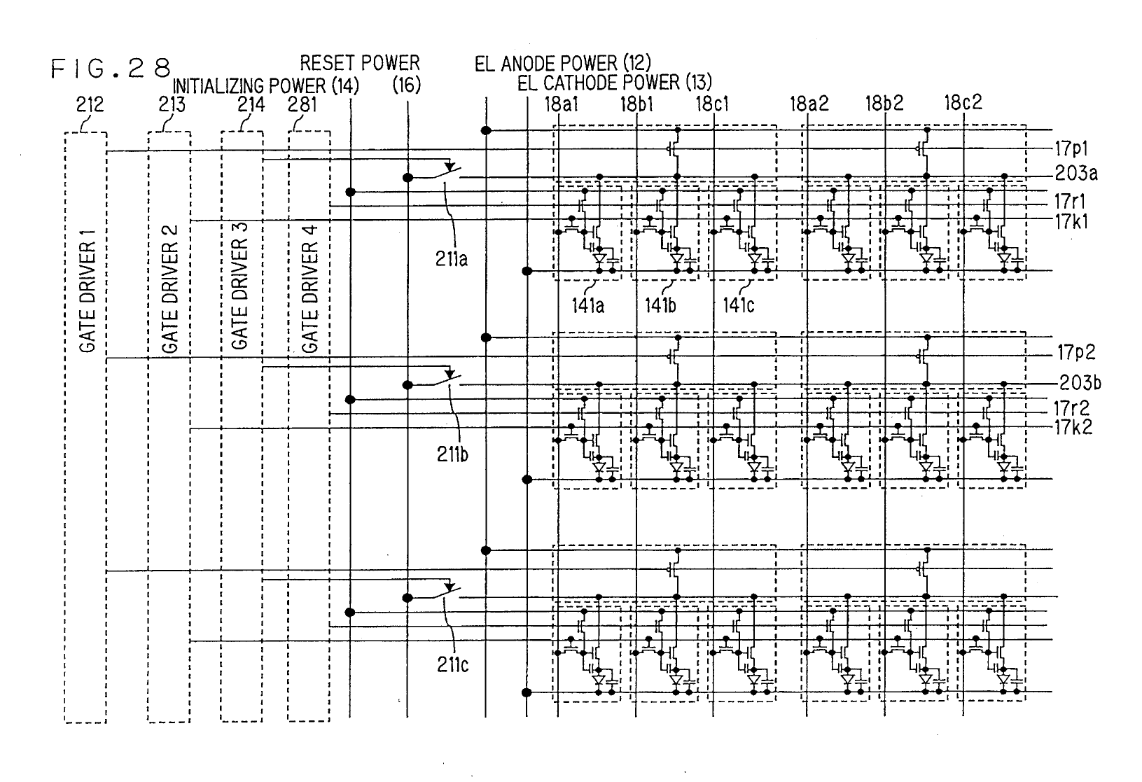

Pixels arranged in the matrix pattern and the configuration of a gate driver unit are shown in FIG. 28. The gate signal line 1 (17p) and the switch 211 may be configured with a common gate driver. Although the switches 11p are provided one for the three pixels, it may be provided one for given pixels.

The capacitance to be connected in parallel to the EL element 15 may be adjusted according to the capacitance of the EL element 15 and a range of a voltage that the video signal data is able to output, and does not necessarily have to be added. Presence and absence of the capacitance may be mixed depending on the display color.

### Fifth Embodiment

An EL display device according to a fifth embodiment will be described.

(1) General Configuration of EL Display Device

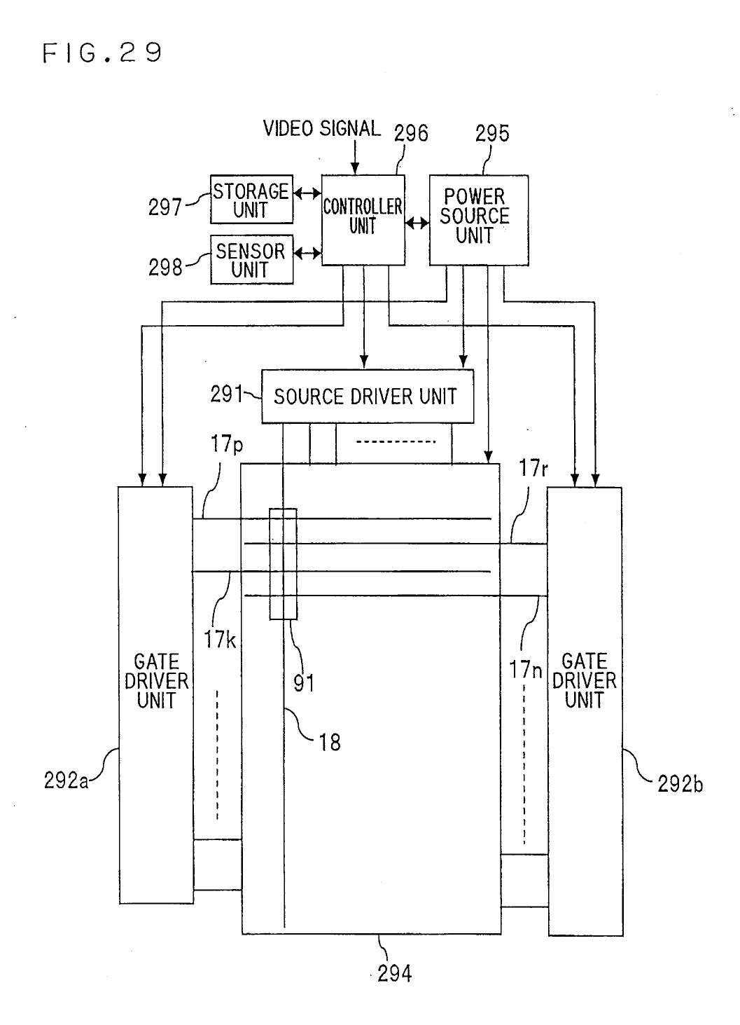

First of all, a general configuration of the EL display device in the fifth embodiment will be described. FIG. 29 is a general configuration of the EL display device.

A source driver unit 291 and a gate driver unit 292 are connected to a display region 294. It includes a controller unit 296 configured to control the driver units and a power source unit 295 configured to generate a power for supplying a current to the power of the driver unit and the El element.

(2) Storage Unit and Sensor Unit

The display unit is controlled using a storage unit 297 and a sensor unit 298 as needed. For example, when the luminance of the EL element 15 is varied depending on the temperature with the same voltage input, a temperature sensor is used as the sensor unit 298 to vary the voltage output to the source signal lines 18 with respect to the video signal input according to the temperature of the display region 294 or the peripheral temperature, so that the luminance change according to the temperature may be corrected.

In addition, by using an optical sensor, controlling to improve the luminance temporarily when the visibility is low due to input of an external light or varying of the voltage of the source signal line when the photo conduction of gate voltage drain current characteristics of the drive transistor 11a affects the display is enabled.

By storing the degree of the change in the storage unit 297, a control pattern may be selected from a plurality of stored patterns when the control method is changed depending on an output from the sensor unit 298.

When characteristics are different among the display colors, the implementation is achieved by storing the characteristics for the respective display colors.

Since the controller unit 296 receives inputs from the sensor and the storage unit, it is also possible to vary the illuminating period 104 by the control of the gate driver, or to vary a power voltage outputted from the power source unit 295 other than to vary a voltage of the source signal line.

When there are variations among the display devices, the variations may be eliminated by storing a correction coefficient in the storage unit 297 for correcting the variations.

(3) Source Driver Unit 291

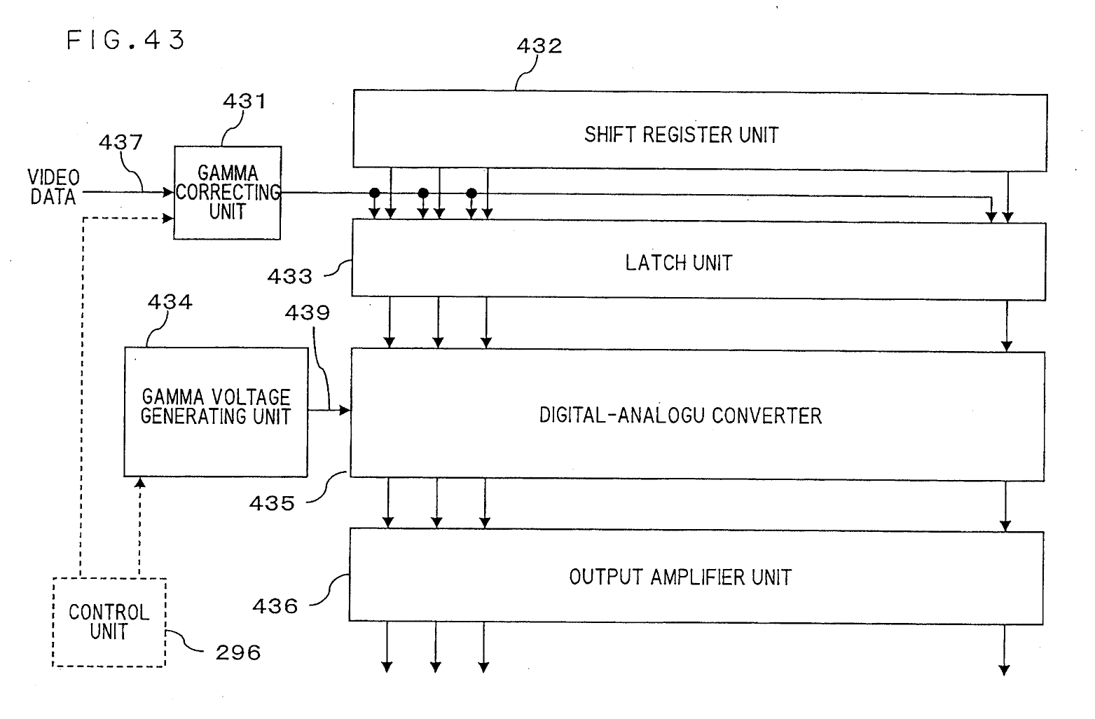

An example of a configuration of the source driver unit 291 is shown in FIG. 43.

By configuring the controller unit 296 to be able to control the voltage setting of a gamma voltage generating unit 434, the range of the output voltage to the source signal line may be varied depending on display colors, temperatures, or intensities of illumination. The controller unit 296 is able to vary a display state on the panel according to the change of a peripheral environment by varying an output voltage from the gamma voltage generating unit 434 on the basis of data in the sensor unit 298 and the storage unit 297 for storing the degree of the variation in advance.

The change of the voltage of the signal may be implemented by a gamma correcting unit 431.

The controller unit 296, the power source unit 295, the sensor unit 298, and the storage unit 297, being individual semiconductor circuits, may be configured in a single semiconductor circuit by integrating a plurality of blocks.

FIG. 43 is an example of the source driver unit 291, and the gamma correcting unit 431 and the gamma voltage generating unit 434 may be included either in the controller unit 296 or in the power source unit 295.

(4) Variations of Luminance

In the pixel circuit in the fifth embodiment, the charge to be stored in the storage capacitance 19 varies depending on the variations of the gate and source voltages of the drive transistor 11a and the voltage between the end of the threshold compensating period 102 and the end of the signal write period 103 of a cathode voltage of the EL element 15, and a current according to the charge in the storage capacitance 19 flows in the illuminating period 104, so that the display is achieved.

The gate voltage of the drive transistor varies from the initializing voltage to the voltage of the video signal, and hence the voltage is varied by the voltage of the video signal, whereby the charge to be stored in the storage capacitance 19 is varied, so that light is emitted according to the gradation. The power inputted from the outside is inputted at a constant value.

However, in the actual EL panel, the output of the power source unit 295 might fluctuate with outside noises, load currents, and peripheral temperatures.

When there is no fluctuations in voltage to be inputted, the voltage of Coled/(Cst+Coled)×(Vdata−Vrst)+VthDRT is applied to the storage capacitance 19, and the corresponding drain current flows in the EL element 15 in the illuminating period 104. Here, the Vdata is the voltage of the video signal data, the Vrst is the voltage of the initializing power 14, the VthDRT is the threshold voltage of the drive transistor 11a.

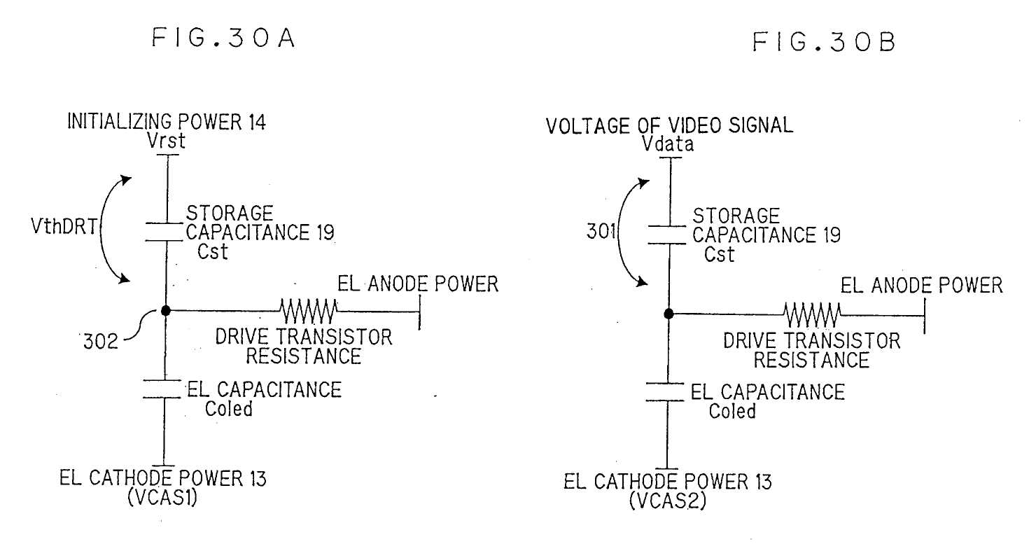

The voltages applied to the storage capacitor and the capacitance of the EL element in the threshold compensating period 102 and the signal write period 103 are shown in FIG. 30A and FIG. 30B, respectively.

When the voltage of the EL cathode power 13 is varied, for example, when it is varied in the threshold compensating period 102 (VCAS1) (FIG. 30A) and the signal write period 103 (VCAS2) (FIG. 30B), a voltage 301 stored in the storage capacitance 19 is expressed by;

Coled/(Cst+Coled)×((Vdata−Vrst)+(VCAS1−VCAS2))+VthDRT,

and shows that the luminance is varied in comparison with a case where the voltage of the EL cathode power 13 does not vary (VCAS1=VCAS2).

(5) Factor Which Causes Voltage of EL Cathode Power 13 to Vary

As a factor which causes the voltage of the EL cathode power 13 to vary, (1) variations in output voltage due to the fluctuation of a load current, (2) variations in voltage by a wire resistance of the EL cathode power 13 from the power source unit 295 to a pixel circuit 91, variations in amount of voltage drop according to a flowing current (3) variations in temperature characteristics of the power source unit, are considered.

(6) Solving Method

The power source unit 295 in the fifth embodiment is characterized in that the voltage or the current of the EL cathode power 13 is measured using the controller unit 296 and the sensor unit 298, so that the voltage of the EL cathode power 13 can be varied according to the result of measurement.

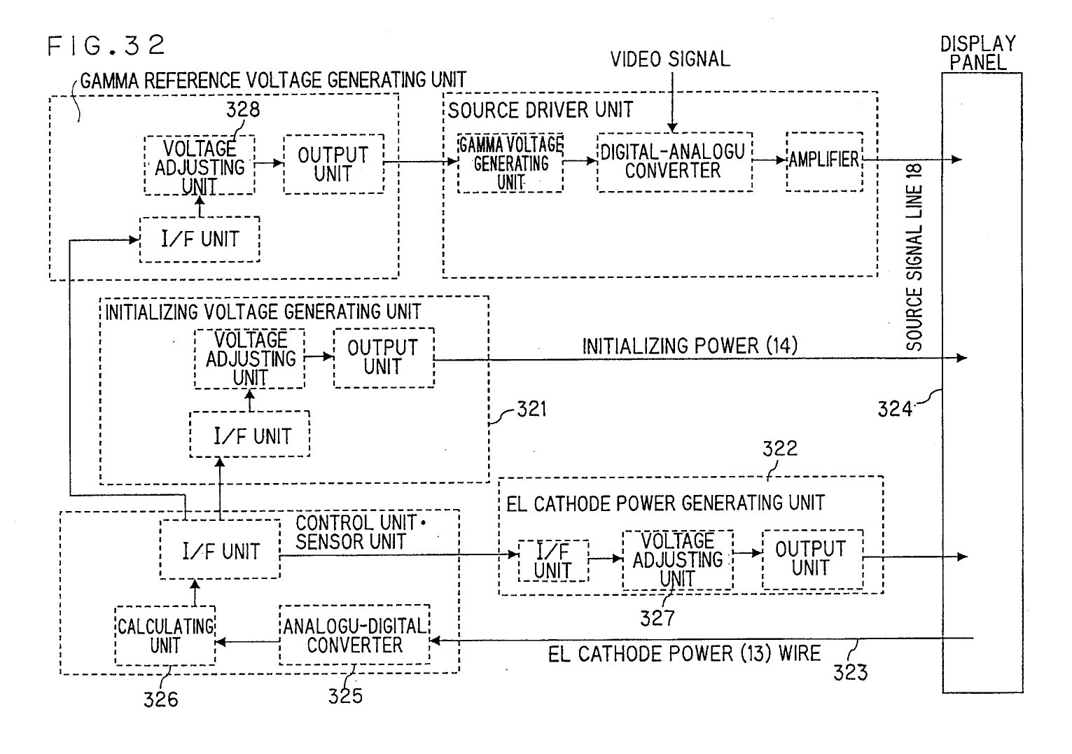

FIG. 32 shows a circuit configuration for reducing the change in voltage of the EL cathode power 13 in the fifth embodiment.

An output of an EL cathode power generating unit 322 generated in the power source unit 295 is inputted to a display panel 324. On the other hand, a wire 323 of the EL cathode power 13 is drawn out from the display panel, so that the voltage of the EL cathode power 13 in the display panel 324 is known.

In order to measure the voltage of the EL cathode power 13, the wire 323 of the EL cathode power 13 is connected to the controller unit 296 or the sensor unit 298 to detect the voltage value in an analog-digital converter 325. Depending on the result of the detection, a calculating unit 326 calculates a voltage value for restraining fluctuations of the voltage of the EL cathode power in the display panel 324 and outputs the result of calculation to the EL cathode power generating unit 322 and a voltage adjusting unit adjusts voltage, so that the control to restrain the fluctuation of the EL cathode voltage in the display panel 324 is achieved.

When the display device is configured as shown in FIG. 29, the control to make the EL cathode power constant in a displayed state is achieved so that the variations in luminance due to the fluctuation of the EL cathode power is prevented.

It is effective for alleviating the variations in output voltage due to the change of the load current or the variations in temperature characteristic of the power source unit.

### Sixth Embodiment

An EL display device according to a sixth embodiment will be described.

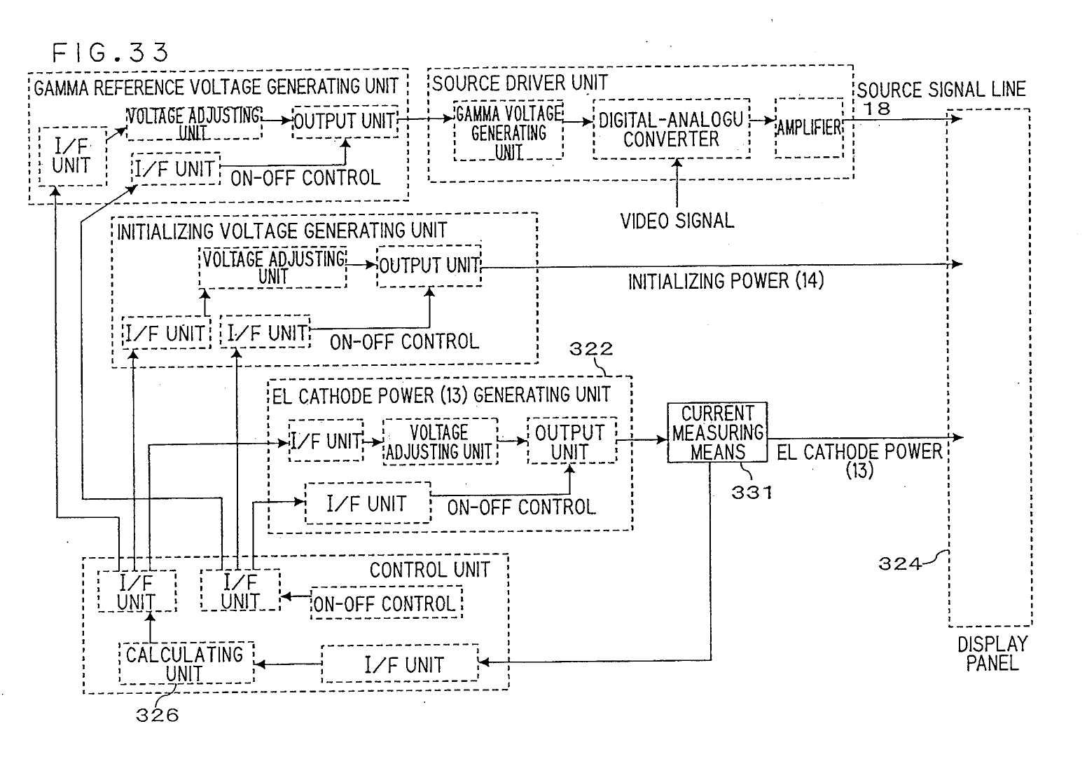

FIG. 33 shows a circuit configuration for reducing the variations in voltage of the EL cathode power 13 in the fifth embodiment.

A different point from FIG. 32 is that the El cathode voltage to be supplied to the display panel is constant irrespective of the output current by being provided with a current measurement means 331 configured to measure an output current of the EL cathode power 13, inputting a detected current data into the controller unit 296, calculating an optimal voltage value by the calculating unit 326 depending on a current value, and providing a feedback to the EL cathode power generating unit 322.

Since the voltage is varied according to the change of the current value, it is necessary to know the variations in output voltage with respect to the output current of the EL cathode power 13 in advance. The calculating unit 326 is adapted to correct the changed output voltage from the current value data. The correction coefficient may be programmed in advance or stored in the storage unit 297 to allow the selection according to the characteristic of the power source unit 295 so as to be capable of calling the correction coefficient from the storage unit 297 and calculating the same.

The correction of the voltage output of the EL cathode power by the current value may support the voltage variations due to the wire resistance of the EL cathode power 13 from the power source unit 295 to the pixel circuit 91.

The current value may be detected by the current measurement means 331, the wire resistance of the EL cathode power is calculated from the layout or the thickness of a wiring layer, and a voltage adjusting unit 327 of the EL cathode power generating unit is controlled by the calculating unit 326 in order to correct the voltage corresponding to the amount of the potential drop in the pixel 91.

Accordingly, the voltage of the EL cathode power 13 in the pixel 91 becomes constant irrespective of the consumed current, so that the variations in luminance due to the fluctuation of the voltage of the EL cathode power 13 is prevented.

### Seventh Embodiment

An EL display device according to a seventh embodiment will be described.

The voltage 301 to be stored in the storage capacitance 19 is;

Coled/(Cst+Coled)×((Vdata−Vrst)+(VCAS1−VCAS2))+VthDRT.

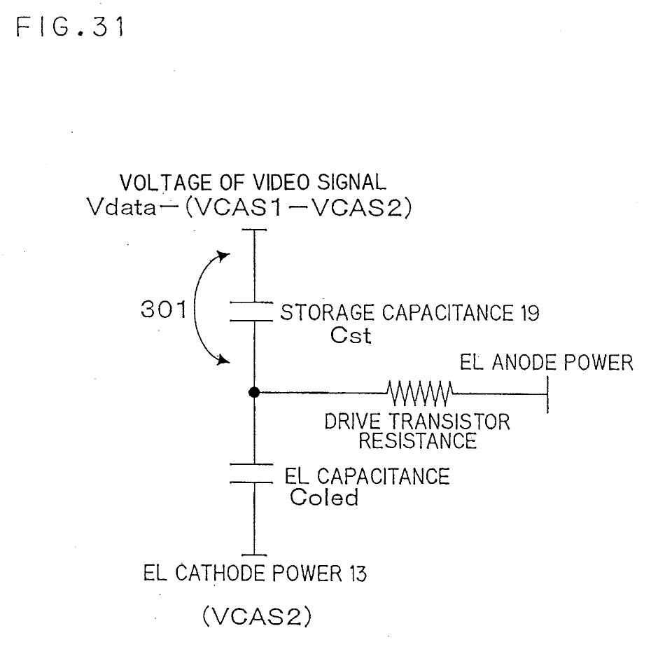

As a method to achieve the same voltage value as the case where the cathode voltage does not vary, there is a method for varying the voltage of the video signal data according to variations in voltage of the EL cathode power 13. As shown in FIG. 31, in the signal write period, by varying the voltage of the video signal from the value of Vdata to the value of Vdata−(VCAS1−VCAS2), the voltage 301 becomes;

Coled/(Cst+Coled)×((Vdata−(VCAS1−VCAS2)−Vrst)+(VCAS1−VCAS2))+VthDRT=Coled/(Cst+Coled)×(Vdata−Vrst)+VthDRT

even when the voltage of the EL cathode power 13 is fluctuated,

so that the same voltage as that in the case where the voltage of the EL cathode power 13 is not fluctuated is applied.

Accordingly, even when there is the change of the potential of the voltage of the EL cathode power 13 between the threshold compensating period 102 and the signal write period 103, variations in luminance can be eliminated by varying the voltage of the video signal data according to variations in voltage of the EL cathode power 13.

As the method for varying the voltage of the video signal data according to the variations in voltage of the EL cathode power 13, as shown in FIG. 32 and FIG. 33, the voltage value or the current value of the EL cathode power 13 is detected, and the voltage corresponding to (VCAS1−VCAS2) is calculated by the calculating unit 326 of the controller unit 296.

Subsequently, the result of calculation is transmitted to the power source unit 295 and inputted into a gamma reference voltage generating unit configured to determine the voltage of the video signal data. The voltage as a reference of the gamma voltage is varied by a voltage adjusting unit 328. When the result is inputted to a gamma voltage generating unit of the source driver unit, the voltage to be outputted to the source signal lines 18 is varied in accordance with the voltage of the EL cathode power 13 even when the same video signal is inputted. Accordingly, the voltage of Vdata−(VCAS1−VCAS2) is outputted from the source signal line in the signal write period 103, and a display with a constant luminance is enabled irrespective of the variations in potential of the EL cathode power 13.

### Eighth Embodiment

An EL display device according to an eighth embodiment will be described.

As a method of making the voltage 301 to be stored in the storage capacitance 19 constant irrespective of the EL cathode voltage, there is a method of varying the voltages of the initializing power 14 and the video signal data according to the fluctuations of the EL cathode power 13.

The voltage value of the EL cathode power 13 as a reference is expressed by VCAS0. The voltages of the initializing power 14 and the video signal when the voltage is the VCAS0 are expressed by the Vrst and the Vdata respectively.

In the state shown in FIG. 30A, the initializing power 14 is changed to Vrst+(VCAS1−VCAS0) according to the change of the EL cathode power 13.

Subsequently, in the state shown in FIG. 30B, the voltage of the video signal is changed to Vdata+(VCAS2−VCAS0) according to the change of the EL cathode power 13.

The voltage 301 generated in the storage capacitance 19 is;

Coled/(Cst+Coled)×((Vdata+VCAS2−VCAS0)−(Vrst+VCAS1−VCAS0)+(VCAS1−VCAS2))+VthDRT=Coled/(Cst+Coled)×(Vdata−Vrst)+VthDRT,

so that the charge may be stored in the storage capacitance 19 irrespective of the EL cathode power 13.

As the method for varying the voltages of the initializing power 14 and the video signal by the EL cathode power 13, as shown in FIG. 32 and FIG. 33, the voltages of the initializing power and the gamma reference voltage are varied according to the output from the EL cathode power.

### Ninth Embodiment

An EL display device according to a ninth embodiment will be described.

Now, the voltage to be stored in the storage capacitance 19 in the video signal write period does not depend on the voltage of the EL cathode power 13. However, there is a problem such that the luminance might vary due to the fluctuations in the voltage Vdata or the voltage Vrt even when the gradation is the same unless the value of (Vdata−Vrst) is kept constant in the write period in the same gradation.

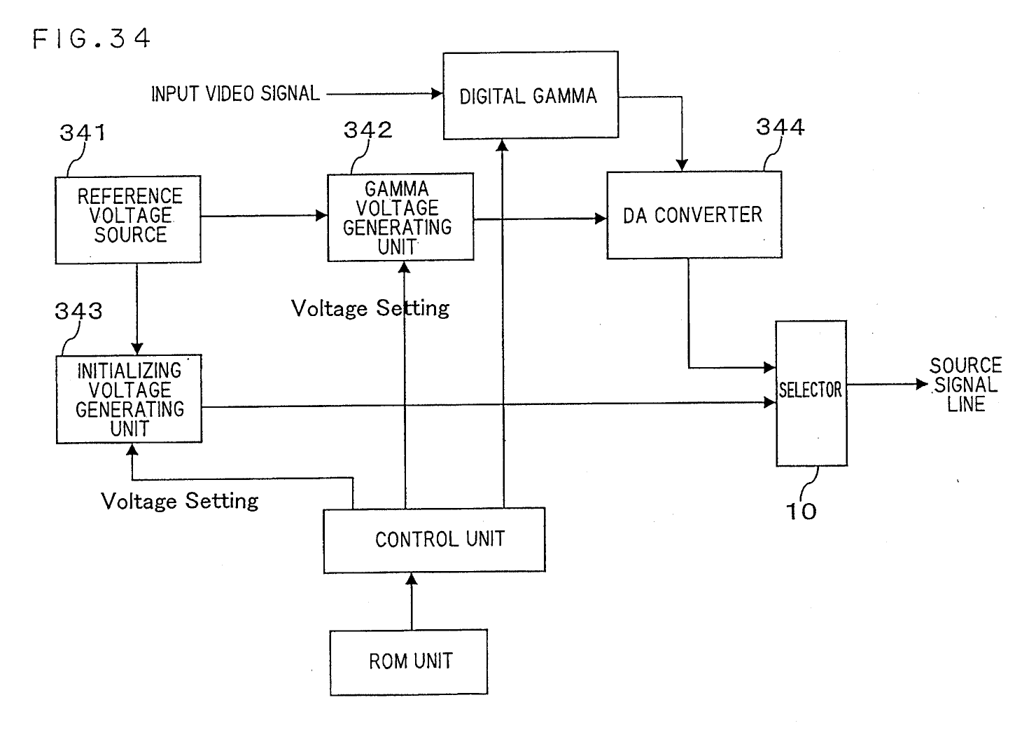

By generating the initializing voltage and the gamma voltage from the same voltage (reference voltage source) as shown in FIG. 34, as a method of making the value of (Vdata−Vrst) constant, the initializing voltage and the gamma voltage fluctuate by the same amount even though the reference voltage fluctuates, and consequently, the value of (Vdata−Vrst) is not varied. Although a reference voltage source 341 is supplied to a gamma voltage generating unit 342 and an initializing voltage generating unit 343, it may be supplied to other powers (for example, EL cathode power 13).

A selector 10 is used in the case of the circuit configuration as shown in FIG. 1. However, in the case of the circuit configuration as shown in FIG. 25, it is not used because the initializing voltage is not inputted to the source signal line. An output of a DA converter 344 is applied to the source signal lines 18.

### Tenth Embodiment

An EL display device according to a tenth embodiment will be described.

As a method of realizing a full-color EL display device, there is a method of arranging pixels having a red EL element, a green EL element, and a blue EL element.

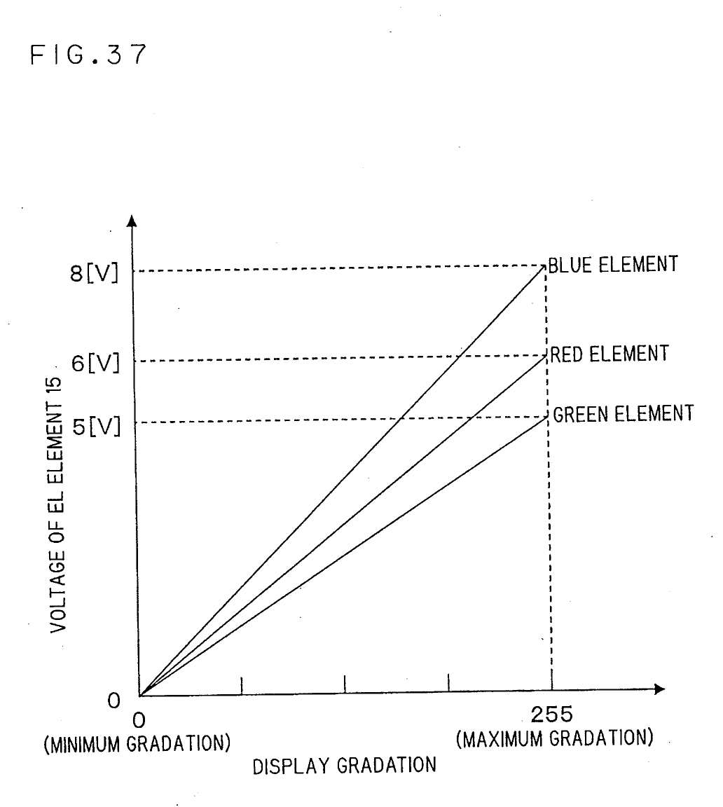

When the light is emitted using different material depending on the display colors, voltages with respect to display gradations of the EL elements 15 are different as shown in FIG. 37.

A potential difference between the EL anode power 12 and the EL cathode power 13 is needed to be set to a value larger than a sum of a maximum voltage to be applied to the EL element 15 (8V in the case of FIG. 37), the source-drain voltage at which the drive transistor 11a is operated as a current control element, a voltage drop due to an ON-resistance of the switch 11p, and the voltage drop due to the wire resistance and a connection resistance.

In order to reduce the power consumption, the smaller potential difference between the EL anode power 12 and the EL cathode power 13 is preferable.

In this embodiment, using the fact that voltages of the EL elements 15 are different depending on the display colors as shown in FIG. 37, the EL anode powers 12 are prepared individually for the display colors.

By preparing the EL anode powers 12 individually, the voltage of an EL anode power 12b for the green element may be lowered by 3V, and the voltage of an EL anode power 12a for the red element may be lowered by 2V without varying the voltage of an EL anode power 12c for the blue element, so that the power of the red element may be reduced by 25%, and the power of the green element may be reduced by 37%.

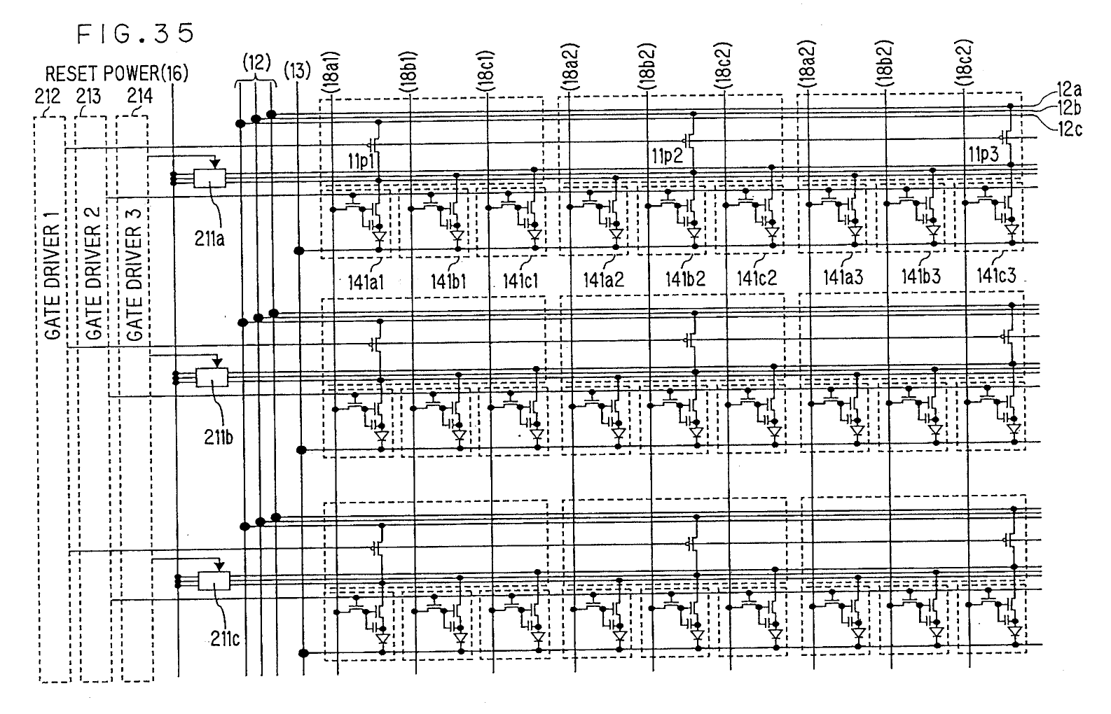

When the voltages of the EL anode powers 12 are set to different voltages depending on the colors, the reset signal lines 203 to be connected thereto via the switch 11p are also needed to be prepared individually. Therefore, when the separate powers are prepared as the EL anode powers 12 for the respective colors in the circuit configuration shown in FIG. 20, the EL anode powers, the reset signal lines, and the switches 211, 11p are arranged as shown in FIG. 35.

The switches 11p are arranged one for three pixels as described above, but are arranged one for three pixels of the same display color in this case. In the example shown in FIG. 35, a switch 11p1 is prepared for the pixels for the red color, a switch 11p2 is prepared for the pixels for the green color, and a switch 11p3 for the pixels for the blue colors.

Since the reset signal lines 203 are formed for the respective display colors, the three switches 211 are required for one row.

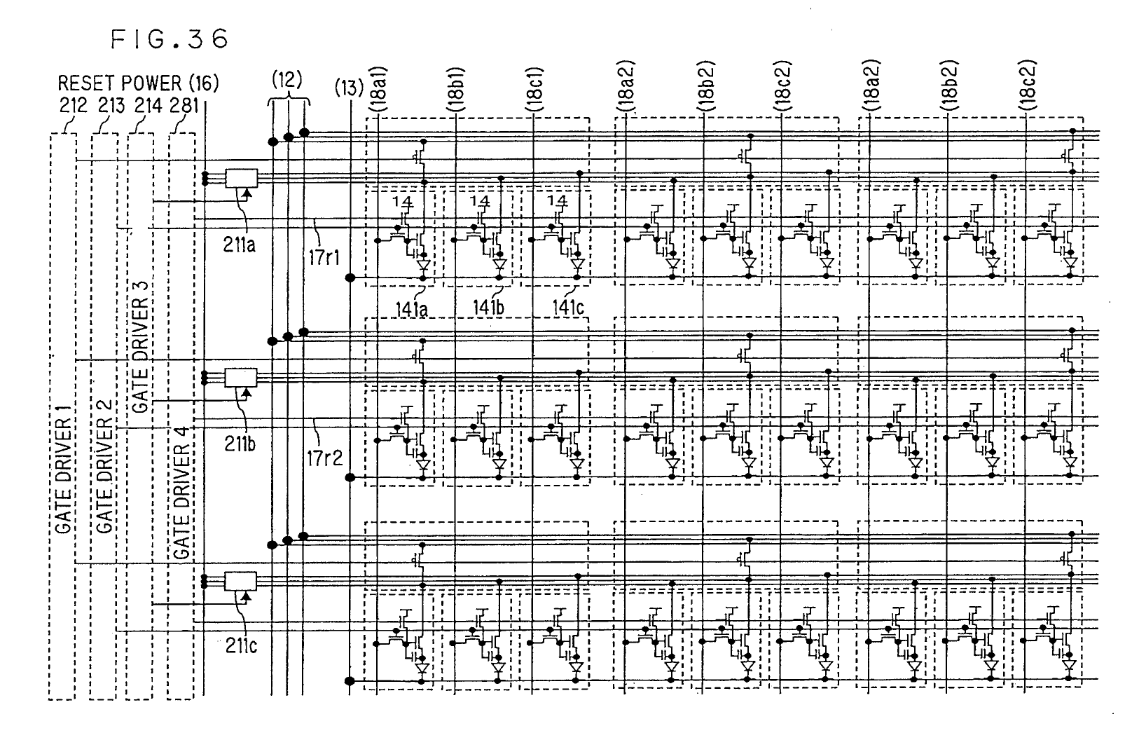

The configuration shown in FIG. 25 in which the wire for the initializing power 14 is drawn to the pixel circuits may also be designed into a configuration as shown in FIG. 36, such that the EL anode powers 12 may be differentiated depending on the display colors.

### Eleventh Embodiment

An EL display device according to an eleventh embodiment will be described.

In the eleventh embodiment, a signal line selecting drive for supplying the video signal to a plurality of source signal lines with respect to the output of one source driver may be implemented.

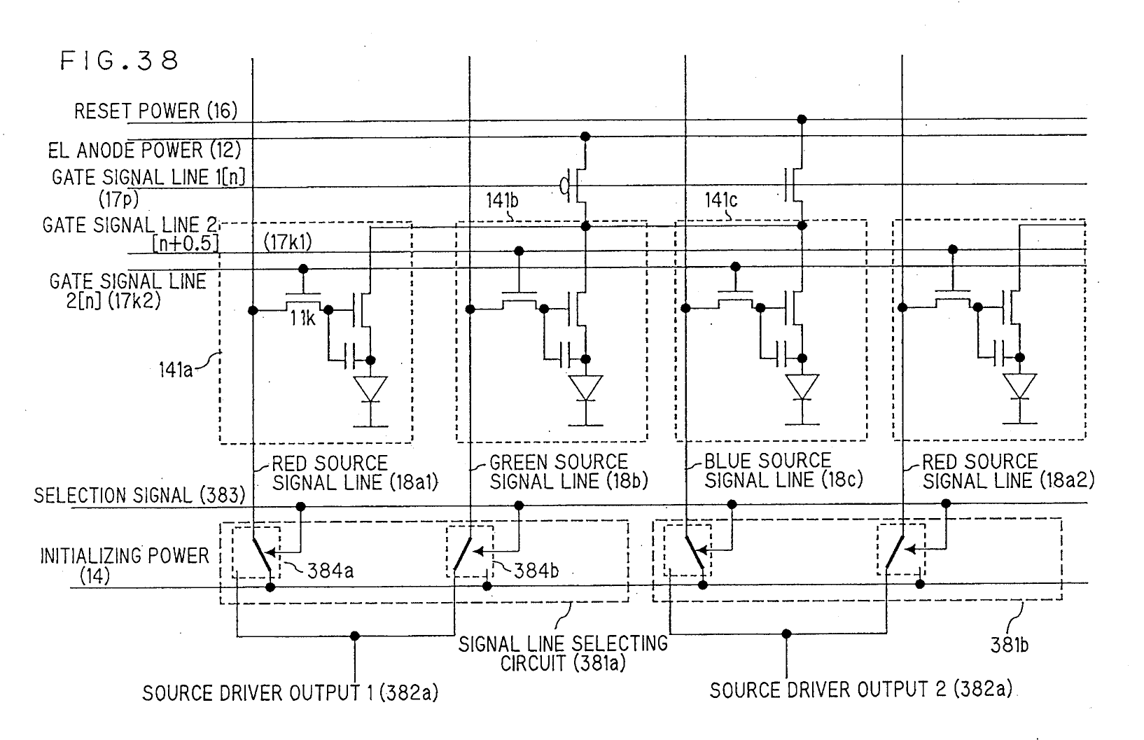

In a selecting drive method in the eleventh embodiment, since a function to apply the initializing power 14 to the source signal lines 18 is provided, the circuit configuration is different from an liquid crystal display apparatus. An example of a two-selecting drive (two source signal liens are driven for one driver output) is shown in FIG. 38. A signal line selecting circuit 381 includes two sets of switching circuits 384 which output one of a source driver output 382 and the initializing power 14 to the source signal lines 18. The two sets of switching circuits 384 are configured to select different ones from each other. In other words, the source driver output 382 is connected to selected one of the source signal lines 18, and the initializing power 14 is also connected to selected one of the source signal lines 18.

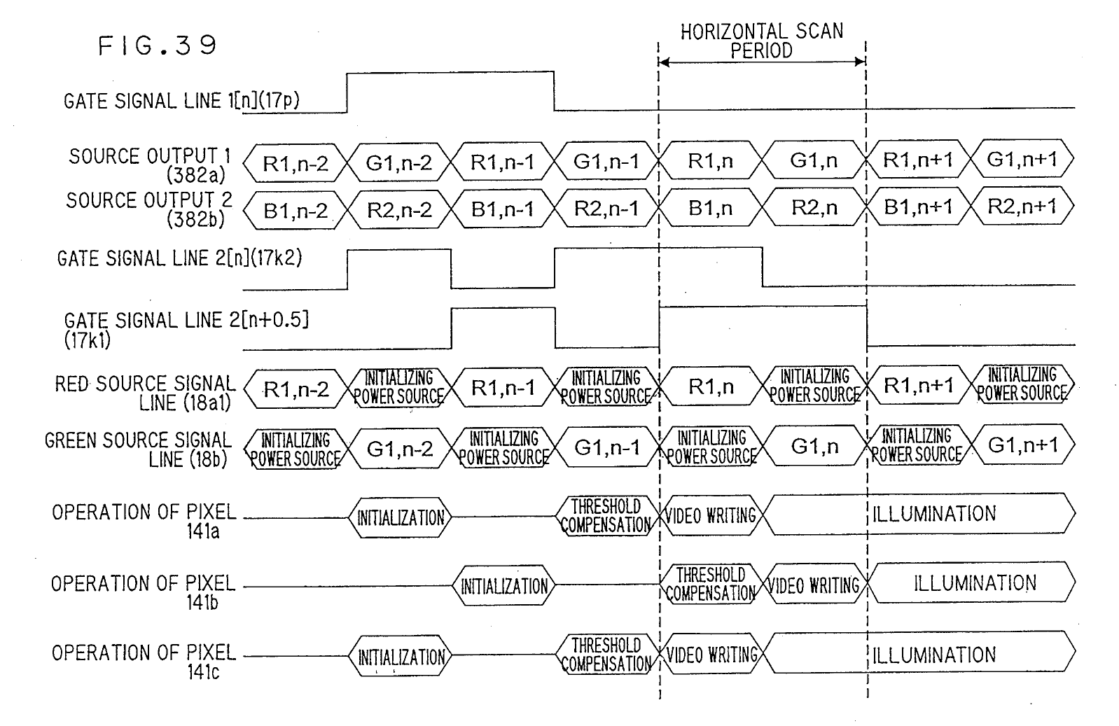

A timing chart of the respective signals is shown in FIG. 39. Data corresponding to the video signals corresponding to two pixels is transmitted to the source driver output 382 in one horizontal scan period at a double speed. Voltages corresponding to the initializing power 14 and the video signal are inputted to the respective source signal lines 18 alternately during one horizontal scan period by the signal line selecting circuit 381.

Since the timing to take the video signal into the pixel 141 is different depending on whether the video signal comes in the former half or in the latter half of the horizontal scanning period, it is necessary to shift the timing of the gate signal line 2 (17k). Therefore, a gate signal line 2 [n] (17k2) is inputted to the pixels to which the video signal is inputted in the former half of the horizontal scan period, and a gate signal line 2 [n+0.5] (17k1) is inputted to the pixels to which the video signal is inputted in the later half thereof. The two signals are inputted by being shifted by 0.5 horizontal scanning period.

When the gate signal line 1 (17p) and the gate signal line 2 (17k) are in a high level, the initializing period is assumed. The voltage of the source signal lines 18 at this time is the voltage of the initializing power 14.

The threshold compensating period 102 is implemented at a timing expressed as “threshold compensation” in FIG. 39, and the pixel circuit 141 performs an offset canceling operation when the gate signal line 1 is in a low level, the gate signal line 2 (17k) is in the high level, and the voltage of the source signal lines 18 is the voltage of the initializing power 14, so that the characteristic variations of the drive transistor 11a are corrected. Subsequently, the writing of the video signal is performed according to the input of the video signal, and the voltage according to the gradation is stored in the pixel 141. After the writing, the illuminating operation is started, in which the EL element 15 emits light and the predetermined luminance is obtained.

In the case where the signal line selecting drive as shown in FIG. 38 is performed as well, the implementation is achieved also in the same manner by applying other pixel circuit configurations.

### Twelfth Embodiment

An EL display device according to a twelfth embodiment will be described.

When the initializing power 14 is inputted via the source signal lines 18, the source signal lines 18 are needed to be applied with the video signal and the initializing voltage alternately, and hence the signal frequency of the source signal lines 18 is increased. There is a problem such that the initializing period 101, the threshold compensating period 102, and the signal write period 103 are shortened according to the increase of the number of pixels in the vertical direction.

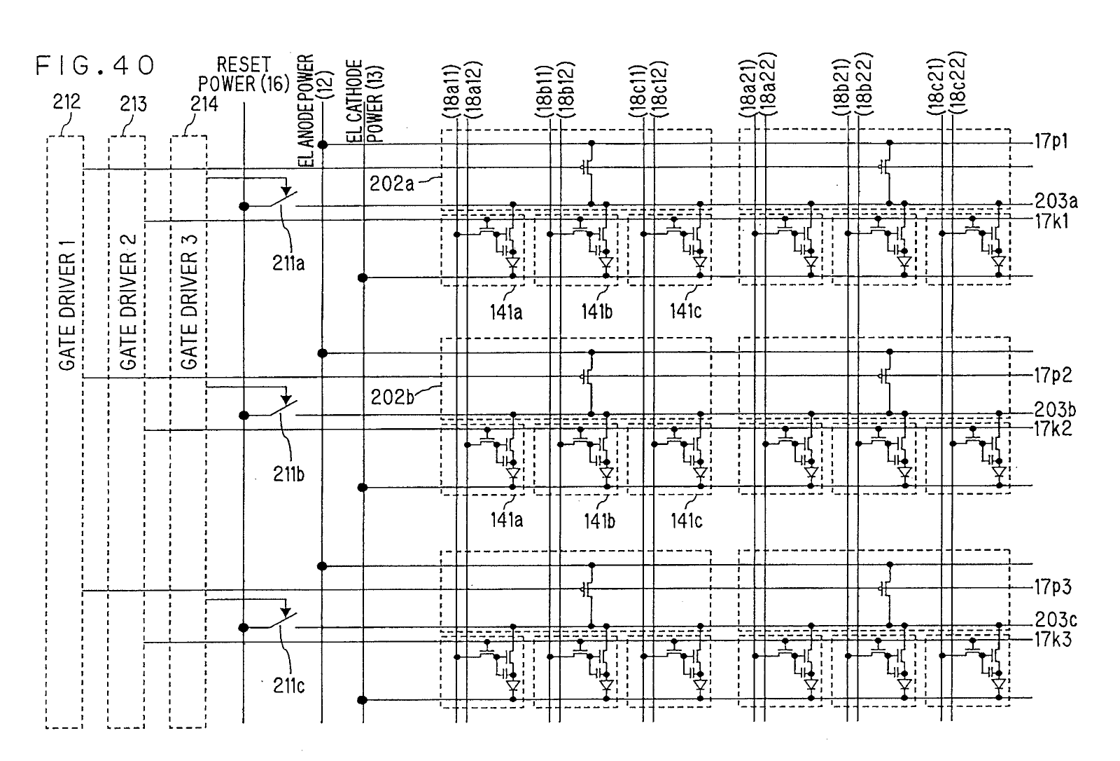

In the twelfth embodiment shown in FIG. 40, the two source signal lines 18 are formed per column, and rows of even numbers and rows of odd numbers are written with the source signal lines 18 different from each other, so that the frequency of the source signal lines 18 is reduced to a half.

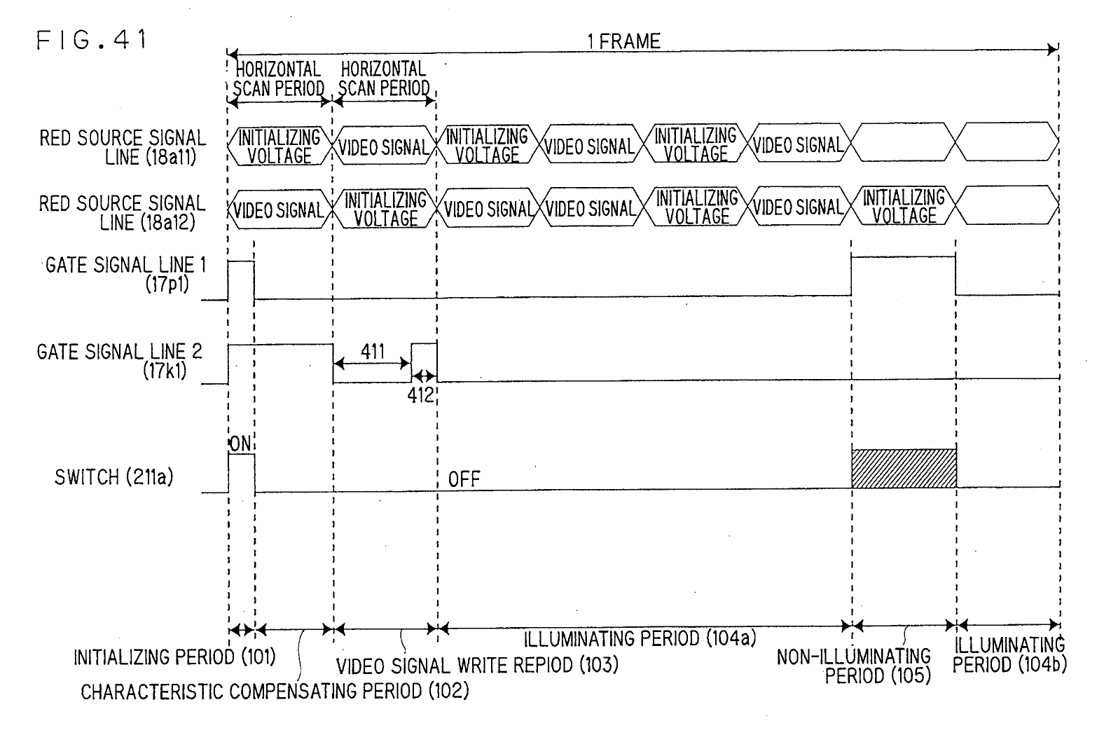

A driving method in a circuit configuration shown in FIG. 40 is shown in FIG. 41. The waveforms of the source signal lines 18 correspond to a first column, and the waveforms of the gate signal lines 17 correspond to a first row.

Since the video signal is applied to the different source signal lines between the rows of even numbers and the rows of odd numbers, when focusing attention on one source signal line 18a11, it varies at intervals of two horizontal scan periods. Since it is necessary to input the initializing voltage, the initializing voltage and the video signal are repeatedly inputted to the source signal lines 18 at every other horizontal scan period as shown in FIG. 41. Since the input timings of the video signal are different between the rows of even numbers and the rows of odd numbers by one horizontal scanning period, the application timings of the video signal and the initializing voltage are inverted between the source signal line 18a11 and the source signal line 18a12.

The drive timing of the gate driver is the same as described above and, consequently, the operation timing of the pixel in the first row and the first column is as shown in the lower part in FIG. 41.

The ratio between an OFF period 411 and an ON period 412 in the signal write period 103 of the gate signal line 2 is arbitrary.

Since the ON period 412 is long, the charge stored in the EL element 15 is increased and, consequently, if the charge to be stored in the storage capacitance 19 is reduced and hence a white display cannot be achieved sufficiently, the ON period 412 may be shortened, while if it takes long time to write in the pixel 141, it may be elongated.

In FIG. 40, the switches 11p are shown one for three pixels, they may be provided one for given n pixels.

### Thirteenth Embodiment

An EL display device according to a thirteenth embodiment will be described.

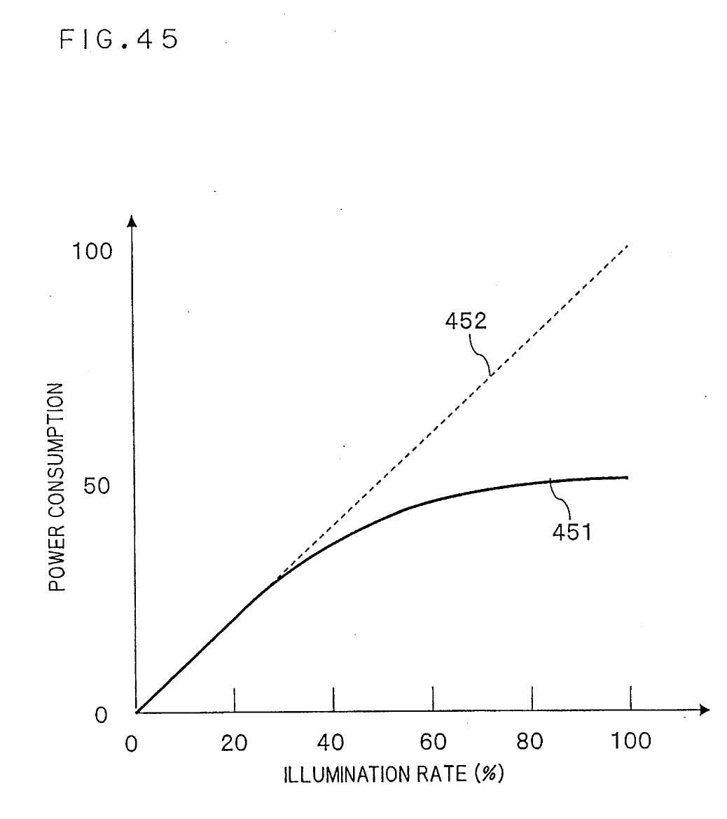

In the display device using the EL element 15, which is the self-emitting element, the longer the high-gradation display (the higher the illumination rate) is, the larger the power consumption becomes, and the shorter the high-gradation display (the lower the illumination rate) is, the smaller the power consumption becomes, so that the relationship as shown by a rectilinear line 452 shown in FIG. 45 is established.

Assuming that the power source unit 295 is able to generate a voltage at a maximum power allowed for the rectilinear line 452, the circuit scales specifically of the EL anode power and the EL cathode power of the power source unit 295 are increased, and the cost is disadvantageously increased. Also, a pattern of an illumination rate of at least 40% does not appear often in the practical use, and has a low appearance ratio, even though the circuit scale of the power is increased with sacrificing the cost increase, little effect is expected.

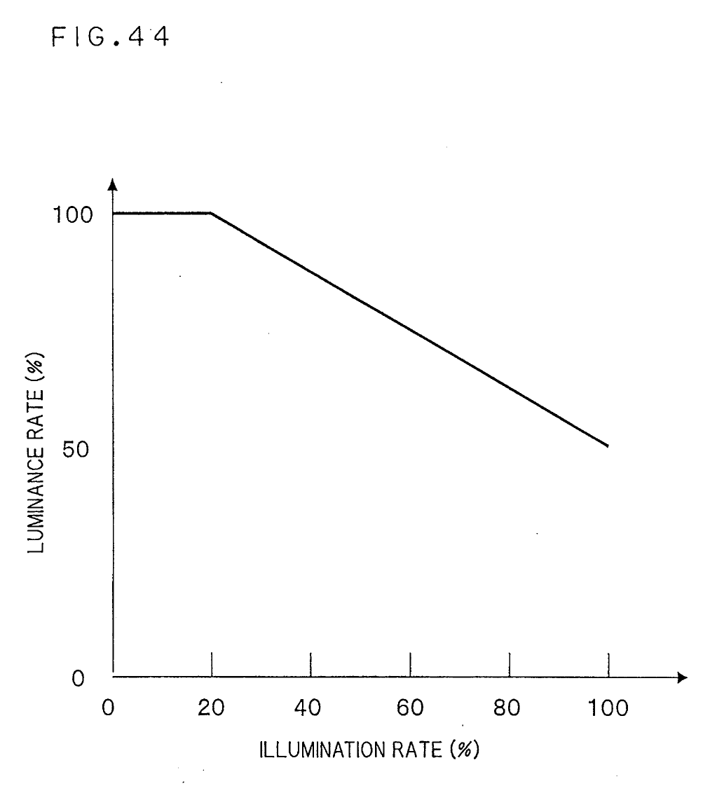

Therefore, as shown by a curve 451 shown in FIG. 45, the increase in power consumption is restrained in the patterns having high illumination rates with increased power consumption. Therefore, the luminance of the respective gradations is varied according to the illumination rates as shown in FIG. 44, and when the illumination rate is high, the luminance is reduced to about a half even in the maximum gradation display.

The influence of reduction of the luminance to a half is negligible in terms of a sense-of-sight performance of human beings and, in FIG. 45, a maximum power consumption is a half the rectilinear line 452, so that there is an advantage such that the power source unit 295 is downsized and hence cost reduction and downsizing of the circuit are achieved.

In comparison with reducing the luminance to a half in the entire area, since the luminance of the maximum gradation display unit is high and hence the contrast is increased correspondingly when the maximum gradation display occurs only partly while most part of the screen is in a dark display, so that a satisfactory display is achieved.

As a method of reducing the power consumption in area region where the illumination rate is high,

(1) The amplitude of the video signal is varied. When the illumination rate is high, a voltage level corresponding to the maximum gradation is not used for amplitude of the source signal line when the luminance rate is low.

(2) The period of illumination in one frame is varied according to the illumination rate, so that the higher the graduation is, the shorter the illuminating period becomes.

### Fourteenth Embodiment

An EL display device according to a fourteenth embodiment will be described.

As a configuration example of the source driver in the fourteenth embodiment, there is a configuration shown in FIG. 43.

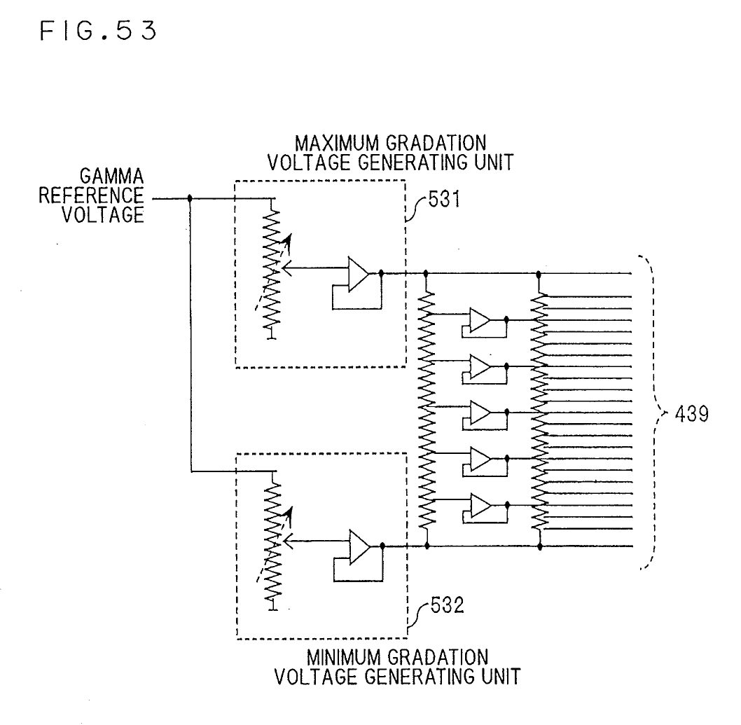

As a method for varying the amplitude of the signal outputted to the source signal lines 18, there is a method for varying the voltage of a maximum gradation voltage generating unit 531 in the gamma voltage generating unit 434 as shown in FIG. 53 according to the illumination rate. When the drive transistor 11a as shown in FIG. 25 in the fourteenth embodiment is of the n-type, the implementation is achieved by lowering the voltage with increase in illumination rate.

The variations in voltage value is controlled by the controller unit 296, and the amount of variation may be programmed in the controller unit 296 in advance, or may be varied according to the value written in the storage unit 297 or the output of the sensor unit 298. (When the sensor unit 298 is used, further increase or decrease of luminance is achieved by the amount of external light.)

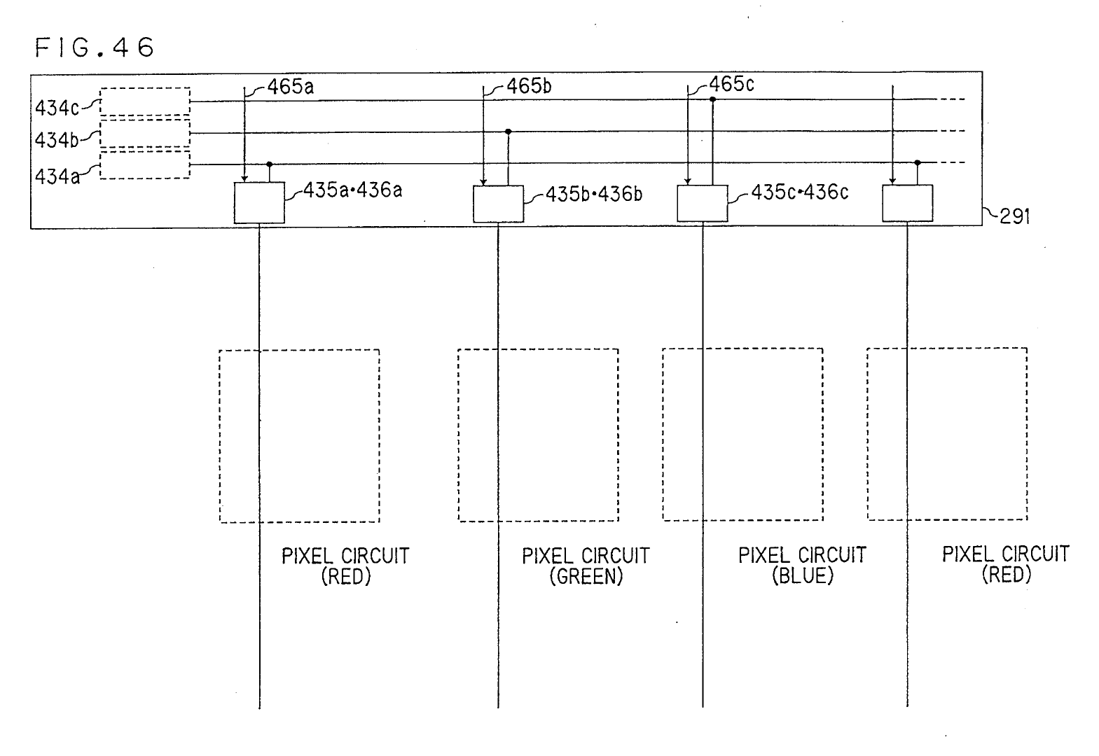

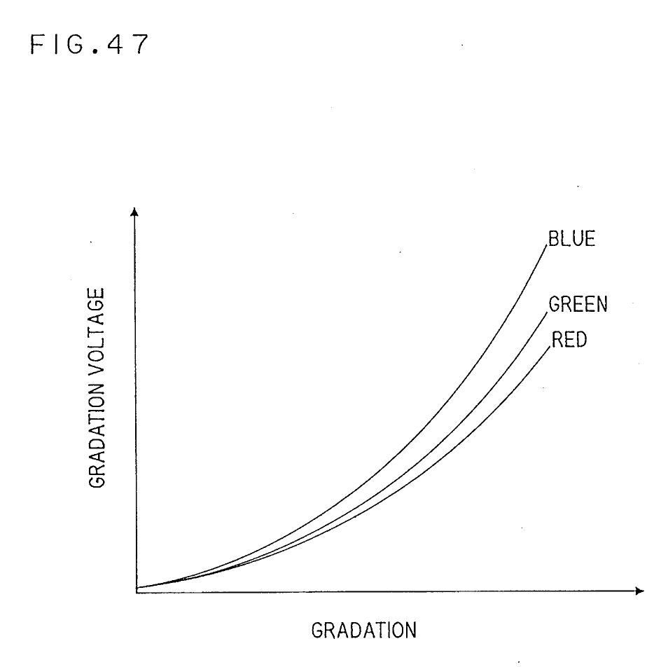

As shown in FIG. 46, gamma curves are different depending on the colors of the EL elements 15. Therefore, when the gamma voltage generating units 434 are formed for the respective display colors in order to input the gradation voltage to the display gradation as shown in FIG. 47, the voltages of the maximum gradation voltage generating unit 531 are preferably adjusted individually for the respective display colors.

### Fifteenth Embodiment

An EL display device according to a fifteenth embodiment will be described.

As a second method for varying the amplitude of the signal, there is a method in which the relation of the output of the gradation to the driver with respect to input data 437 is changed according to the illumination rate in the gamma correcting unit 431 shown in FIG. 43. For example, assuming that the luminance of the EL element 15 is reduced to a half when the output gradation to the driver is reduced to 75% with respect to the maximum gradation set so far, the output voltage of the source driver is varied by outputting the input data 437 as is by the gamma correcting unit 431 if the illumination rate is low, outputting data of 0.75 times the input data if the illumination rate is the maximum, whereby the variations in luminance as shown in FIG. 44 are achieved.

### Sixteenth Embodiment

An EL display device according to a sixteenth embodiment will be described.

In the case of a method for reducing the current consumption by the voltage of the source signal line, the maximum gradation voltage (expressed by VmaX) is lowered with increase in illumination rate in the case of the n-type drive transistor.

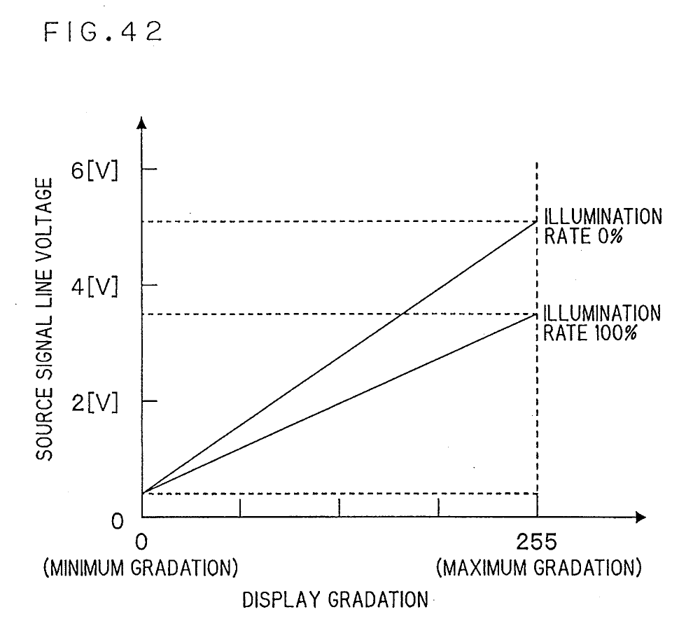

For example, when the illumination rates are 0% and 100%, the voltages of the source signal line with respect to the gradation are as shown in FIG. 42.

When the maximum gradation voltage is lowered, the voltage required for the EL element 15 is also lowered.

The higher the illumination rate is, the lower the potential difference between the EL anode power and the El cathode power may be set in association with the lowering of the maximum voltage required for the EL element 15.

The power source unit 295 in the sixteenth embodiment has the circuit configuration as shown in FIG. 29, FIGS. 32 to 34. Therefore, the configuration may be adapted in such a manner that the illumination rate is calculated and, simultaneously the voltage required for the EL element 15 is calculated by the controller unit 296 which controls the voltage of the driver, whereby the voltage adjusting unit 327 of the EL cathode power generating unit 322 is controlled according to, for example, the illumination rate to increase the EL cathode voltage.

Since the power consumption is ((El anode voltage)−(El cathode voltage))×((current flowing between both powers), there is an effect of reducing the current flowing in the EL elements 15, that is, between the powers and, in addition, further reduction of the power consumption is enabled because the source voltage difference is reduced.

The implementation is achieved in the same manner also by varying the EL anode voltage. Although the EL cathode power is not shown in FIG. 32, the implementation is achieved by configuring the circuit in the same manner as that of the EL anode power.

It is also possible to vary the EL anode voltage individually according to the display colors.

### Seventeenth Embodiment

An EL display device according to a seventeenth embodiment will be described.

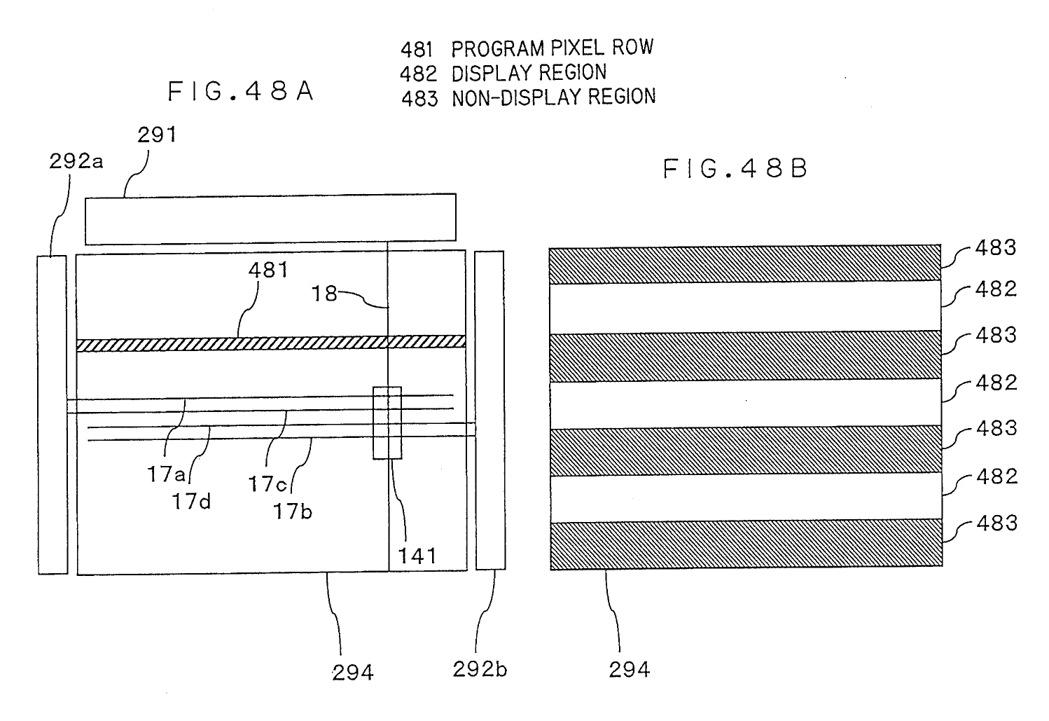

According to a method for varying the illuminating period in one frame, as shown in FIGS. 48A and 48B, illumination or non-illumination is set for every row to form display regions 482 and non-display regions 483 as shown in FIG. 48B.

When the illumination rate is low, by illuminating the non-display regions other than those of the initializing period, the threshold compensating period, and the write period (a programmed pixel row 481 in this case) in which the illumination is not possible in principle, the luminance may be increased. The non-display region exists when the high-luminance is not necessary, or when the black displays are inserted for improving the responsiveness for dynamic images. However, since it has nothing to do with the power consumption, the regions other than the programmed pixel row 481 are described as the display region 482 when the illumination rate is low (20% or lower) for simplifying the description.

Reduction of the luminance ratio when the illumination rate is 100% to 50% is achieved by inserting the display regions 482 and the non-display regions 483 substantially equally as shown in FIG. 48B.

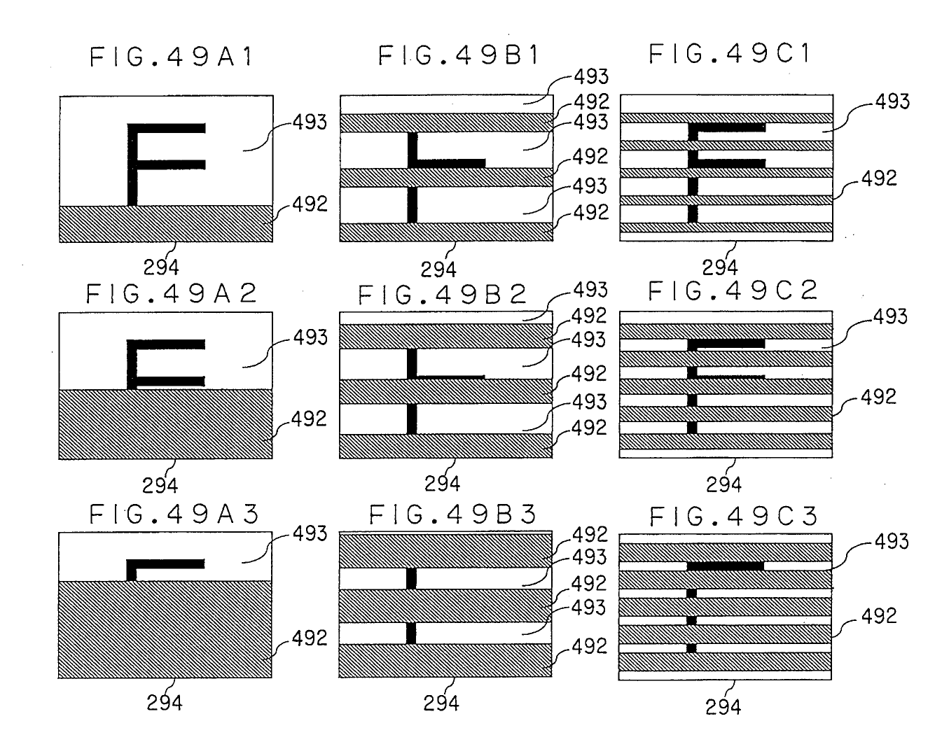

The variation of the luminance ratio according to the illumination rate as shown in FIG. 44 is achieved by varying the size of the display regions 482 gradually according to the illumination rate. For example, as shown in FIGS. 49A1, 49A2, and 49A3, a non-display region 492 is increased with increase in illumination rate. When the flicker occurs, the non-display regions 492 may be inserted by dividing as shown in FIGS. 49B1 to B3 or 49C1 to C3.

In the pixel circuit in the seventeenth embodiment, the display regions 482 and the non-display regions 483 may be set easily by the control of the switch 11p. In many cases, the gate driver is generally configured by a shift register circuit, and only the waveform of the start pulse of the gate driver. Therefore, it is advantageous that little additional circuit for reducing the current consumption according the illumination rate is necessary.

The determination of the size of the non-display regions 492 are the same as the determination depending on the length of the light emitting period in terms of one pixel. If the ON period (illuminating period 104) is varied in one frame of the gate signal line 17p, the size of the non-display regions 492 may also be determined.

As a method of implementing the repetition of the non-display regions 483 and the display regions 482 as shown in FIG. 48B, the illuminating period 104 and the non-illuminating period 105 are implemented by the number of times corresponding to the number of divided regions of the illuminating period 104 and the non-illuminating period 105 in one frame.

In the luminance adjustment by varying the video signal, the gradation performance is lowered when the luminance of the display screen is low. In other words, a 1024 gradation display is realized when the display is the high luminance display, while only a half the number of gradations can be displayed when the display is the low-luminance display. In contrast, in the drive method according to the seventeenth embodiment, the maximum 1024 gradation display is achieved without depending on the display luminance of the screen.

A combination of variations in video signal (voltage of the source signal line) and variations in the non-display region may be implemented.

(Modification)

The same effects are achieved with a combination of the plurality of embodiments of the invention.

Although the switch has been described as a MOS transistor, it may be implemented also by replacing with the MIS transistor and the diode in addition to the MOS transistor as long as it is an element which is adapted to perform a switching operation.

The transistor in the embodiments may also be implemented by a bipolar transistor in addition to the TFT. As regards the TFT as well, the polysilicon, crystal silicon, and amorphous silicon may also be implementable.

It is also possible to implement by combining the above-described embodiments.

As the pixels in the EL display device in the embodiments, the single-color pixel configuration, three colors of red, green, and blue, four colors of red, green, blue, and white, three colors of cyan, yellow, and magenta, a pen tile pixel configurations are applicable irrespective of the display colors.

The pixel configuration in which red, green, and blue are arranged in the embodiments is only an example.

Although the pixel configuration of one row is shown in FIG. 14, FIG. 16, and others, configurations such as a stripe pattern or a delta pattern are also applicable.

The embodiments are also implementable also with the transistors 11 of the p-type and the n-type except for the drive transistor 11a.

As regards the drive transistor 11a, the embodiments are implementable with any of the p-type and the n-type as long as the pixel circuit is formed in such a manner that current paths are inverted between the p-type and the n-type.

The circuit configuration in which the gate drivers are arranged on the left and right sides, and the source driver is arranged on the upper side has been exemplified in the description of the embodiments, the embodiments may be implemented even when the gate drivers are arranged on the upper and lower sides, and the source drivers are arranged on the left and right sides only by adjusting the layout of the wiring of the source signal lines and the gate signal lines.

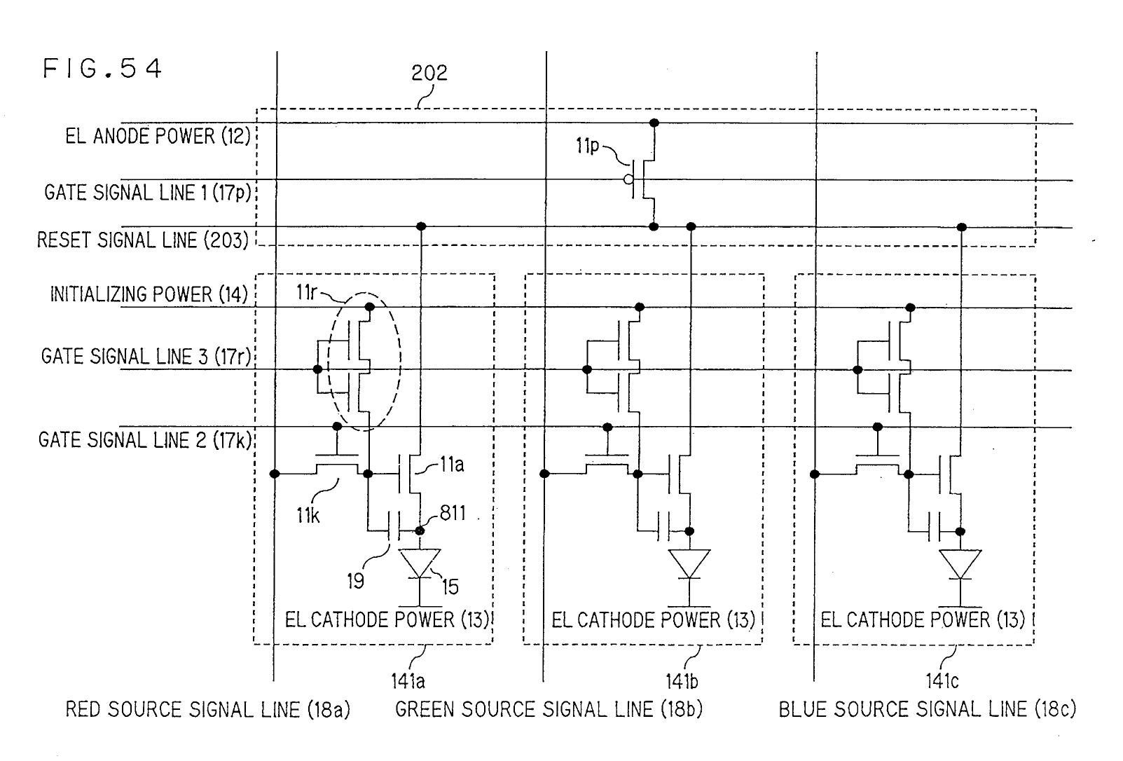

The transistor used as the switch in the embodiments is shown in the drawings as one transistor, if an off leak is significant, a plurality of transistors may be inserted in series (for example, the switch 11m, the switch 11k, and the switch 11r, etc.) or a transistor in a multi-gate configuration may also be used. For example, an embodiment shown in FIG. 54 which corresponds to FIG. 25 is exemplified. The switch 11r includes two transistors. When the ON resistance is not sufficient, the implementation is also achieved with a plurality of transistors connected in parallel.

(Application)

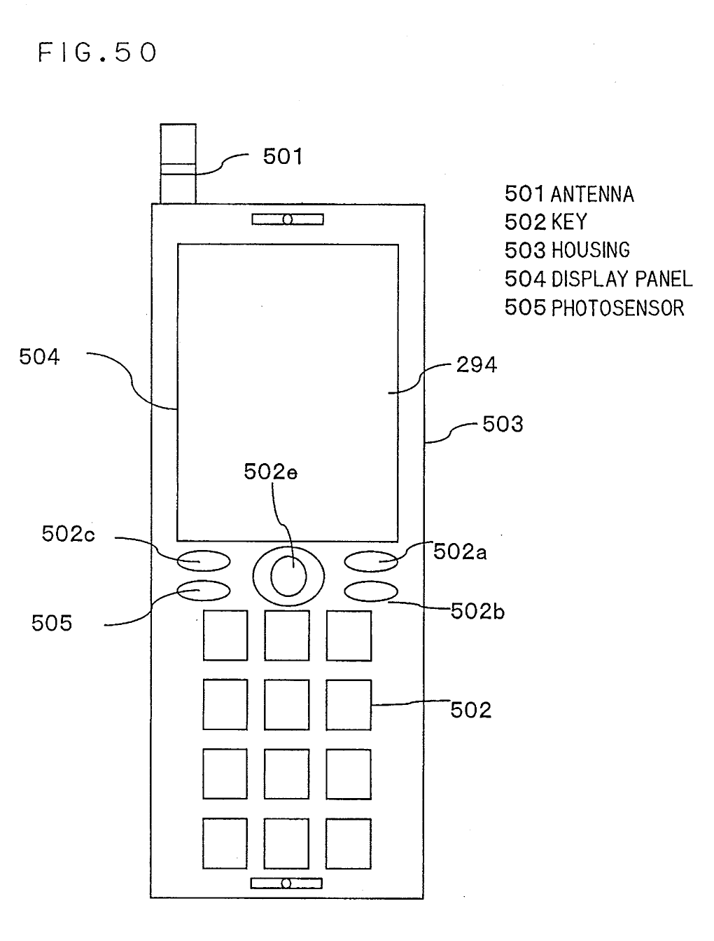

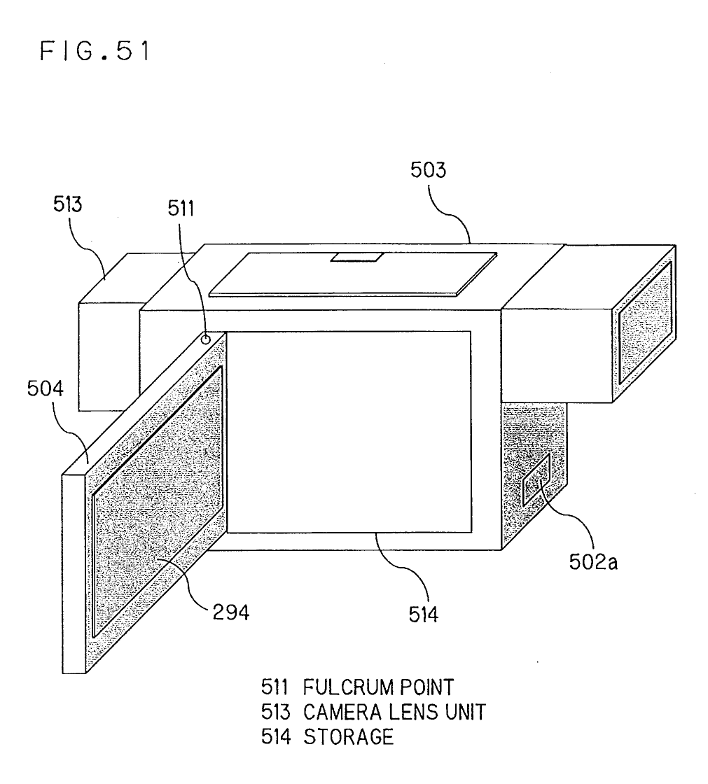

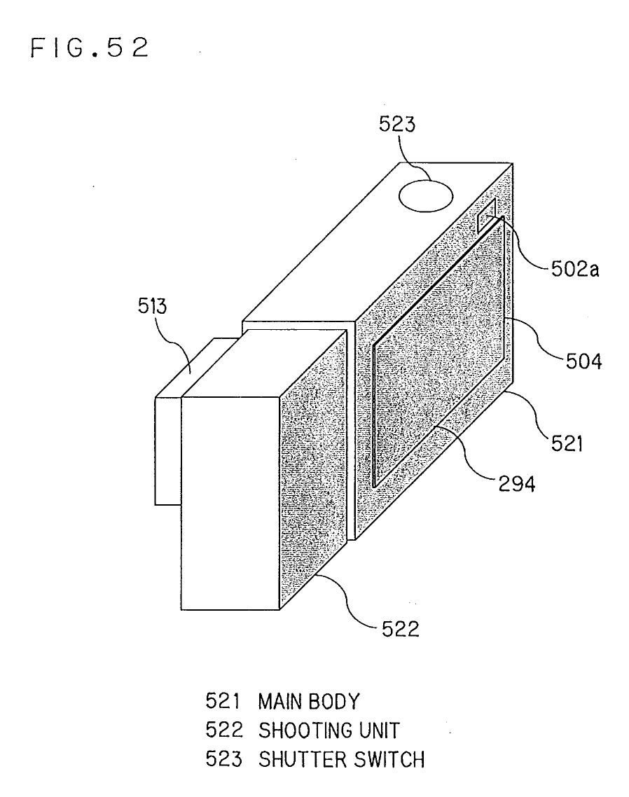

The display device shown in FIG. 29 using the pixel circuits in the configurations shown in FIGS. 1, 5, 9, 20, 22, and 25 may be used as a display unit 294 of a personal digital assistant shown in FIG. 50, a video camera shown in FIG. 51, and a digital camera shown in FIG. 52.

Such apparatuses include a high-definition panel mounted thereon, which has a small pixel surface area. On the other hand, a low power consumption is strongly demanded because they are operated by batteries. Therefore, these apparatuses are optimal for applying the display devices in which the EL element is employed according to the embodiments.

In the personal digital assistance shown in FIG. 50, a photosensor 505 determines whether the external light is strong or weak, and automatically adjusts the luminance of the display screen 294 by the EL display device according to the embodiments.

It is also possible to achieve such display that the luminance is increased immediately after the operation with the operation of keys 502 and is reduced after a certain period of time.

FIG. 51 is a perspective view of the video camera. The video camera includes a camera (image capturing) lens unit 513 and a video camera main body 503. The EL display panel according to the embodiments is used as a display monitor 504. The display screen 294 is freely adjustable in angle about a fulcrum point 511. When the display screen 294 is not used, it is stored in the storage 514.

The EL display panel and the EL display device according to the embodiments may be applied not only to the video camera, but also to an electronic camera as shown in FIG. 52. The EL display device in the embodiments is used as the monitor 294 attached to a camera main body 521. The camera main body 521 is provided with a shutter 523.

In the display device according to the embodiments, the storage unit 297 may store individual values for the respective display devices. By determining a value to be written in the storage unit 297 in the manufacturing process, the variations generated in the course of manufacture may also be corrected.

When all the colors are varied in common, the variations in luminance may be adjusted to fall within a certain range, and when individual variation depending on the colors are allowed, adjustment of the chromaticity is also possible. Also, if a function to set the voltage of a center tap of the gamma is provided, the gamma curve may be adjusted on the panel to panel basis. When the adjustment is performed, it is necessary to store setting values on the panel-to-panel basis, and to provide the storage unit 297 in the display device. The storage means may be provided at any place such as being integrated in the source driver, or being formed as an IC and integrated in another IC. In the pixel configuration in the embodiments, the additional capacitor may be formed in parallel to the EL element 15.

What is claimed is:

1. An EL display device comprising:
a plurality of pixels arranged in a matrix pattern, the pixels each including an EL element and a drive transistor configured to define a current to be supplied to the EL element, and
switches configured to supply a reset power to the drive transistors of the respective pixels and provided one each for a row or plural rows of the pixels arranged in the matrix pattern.

2. The EL display device according to claim 1, comprising switches configured to supply an EL anode power to the drive transistors of the respective pixels, the switches being provided one each for the plurality of pixels arranged in the same row from among the pixels arranged in the matrix pattern.

3. The EL display device according to claim 2, comprising a capacitance being connected in parallel to the EL element.
